(19) United States
(12) Patent Application Publication
(10) Pub. No.: US 2003/0182464 A1
(43) Pub. Date: Sep. 25, 2003

(54) Management of message queues

(76) Inventors: Thomas E. Hamilton, Marlborough, MA (US); Kevin Kicklighter, Centerville, MA (US); Charles R. Davis, Carlisle, MA (US)

Correspondence Address: FISH & RICHARDSON PC, 225 FRANKLIN ST, BOSTON, MA, 02110, US

(21) Appl. No.: 10/077,083

(22) Filed: Feb. 15, 2002

(51) Int. Cl. G06F 9/46; G06F 15/16

(52) U.S. Cl. 709/314; 709/213

(57) ABSTRACT

Managing messages by storing messages in queues and providing a macro queue that is associated with the queues. An application programming interface is initiates a request to the macro queue to obtain a message stored in one of the queues without identifying a particular queue. The macro queue selects a queue from among the queues, and then selects a message from the selected queue. The macro queue may select a message from a queue based on queue priority or queue service time quality. A remote queue proxy is used to establish a communication link between a remote application programming interface and the macro queue. The queues and the macro queue are implemented using object oriented programming principles.

### TECHNICAL FIELD

This invention relates to management of message queues.

### BACKGROUND

Message queues are used to allow processes to communicate across networks and systems. Messages are sent between processes to provide information or request information. When an application receives a request message, it processes the request by reading the contents of the message and acting accordingly. If required, the receiving application can send a response message back to the original requester. The messages sent between senders and receivers are kept in queues. The message queues prevent messages from being lost in transit (such as when one part of the network or system is out of service), and provide a place for receivers to look for messages when the receivers are ready to receive them.

In general, in one aspect, the invention is directed towards a method of managing messages by storing messages in queues, providing a macro queue associated with the queues, calling an application programming interface (API) to initiate a request to the macro queue to obtain a message stored in one of the plurality of queues without identifying a particular queue, and selecting a queue from among the plurality of queues and selecting a message from the selected queue.

Implementations of the invention may include one or more of the following features. A priority value may be assigned to each of the plurality of queues, and the macro queue may select a message from a queue having the highest priority value. The macro queue may also select a message that has been stored in the plurality of queues for the longest time. A remote queue proxy is provided for establishing a communication link between a remote application programming interface and the macro queue. The queues and the macro queue may be software objects that are implemented using object oriented programming principles. The API calls a function (or a “method” as commonly used in object oriented programming literature) related to the macro queue object to associate a queue object with the macro queue object, upon which the function returns a queue instance pointer pointing to the location of the queue object and a priority value representing the priority of the queue. The API calls another function related to the macro queue object to remove the association between the macro queue and a queue.

An advantage of the invention is that by using a macro queue that is associated with a number of queues, the API can retrieve a message from a number of queues in the same way as retrieving a message from a single queue. The API does not need to know how many queues there are, nor does the API need to know whether the individual queues are prioritized, and how the queues are prioritized. Because the API does not have to manage and service the queues individually, this greatly simplifies the software code necessary for writing the API.

In general, in another aspect, the invention relates to a method of managing messages by providing an API to allow a producer module to send a message to a macro queue that manages a number of queues, the API sending the message to the macro queue without identifying one of the queues.

Implementations of the invention may include one or more of the following features. The macro queue may select the first queue that is available among the plurality of queues and sends the message to the selected queue. The macro queue may also duplicate the message and send the message to all of the plurality of queues. The macro queue may select a queue from among the plurality of queues that has the fastest response time based on previous response time records and send the message to the selected queue. The macro queue may also select a queue by cycling through each of the queues in a round robin fashion, and send the message to the selected queue. The macro queue and the queues may be implemented as software objects according to objected oriented programming principles.

An advantage of the invention is that by using a macro queue that is associated with a number of queues, the API can send a message to a number of queues in the same way as sending a message to a single queue. The API does not need to know how many queues there are, nor does the API need to know whether the individual queues are prioritized, and how the queues are prioritized. Because the API does not have to manage and service the queues individually, this greatly simplifies the software code necessary for writing the API.

In general, in another aspect, the invention is directed towards a method of managing queue elements by keeping a list of queue pointers, each pointer pointing to one of a number of queues, receiving a request for adding a queue element, and servicing the request by selecting one or more queue pointers from the list based on a predetermined criterion and adding the queue element to the one or more queues that the selected one or more queue pointers are pointing to.

Implementations of the invention may include one or more of the following features. The predetermined criterion may be to select a queue pointer pointing to a queue that has the shortest response time. The predetermined criterion may be to select all of the queue pointers. The predetermined criterion may also be to select a queue pointer from the list in a round robin fashion by cycling through each of the queue pointers in the list.

In general, in another aspect, the invention is directed towards a method of managing queue members by keeping a list of queue pointers, each pointer pointing to one of a number of queues, receiving a request for retrieving a queue element, and servicing the request by selecting one or more queue pointers from the list based on a predetermined criterion and retrieving a queue element from the one or more queues that the selected one or more queue pointers are pointing to.

Implementations of the invention may include one or more of the following features. The predetermined criterion may be to select a queue pointer pointing to a queue that is the first one to be available. Each of the queues may have a priority value, and the predetermined criterion may be to select a queue pointers pointing to a queue having the highest priority value.

In general, in another aspect, the invention is directed towards a method for messages communication in a distributed system by providing an application programming interface on each computer of a group of computers in the distributed system, providing a remote queue proxy on each of the computers of the group, initiating a request through an application programming interface on a first computer of the group, and passing the request to a second computer of the group by passing the request through the remote queue proxy on the first computer and the remote member queue proxy on the second computer.

Implementations of the invention may include one or more of the following features. The application programming interface is implemented as software objects using object oriented programming principles. The remote queue proxy is also implemented as software objects using object oriented programming principles.

In general, in another aspect, the invention is directed towards a method for passing messages between processes in a distributed system by providing an application programming interface to processes hosted on computers of the distributed system, passing a first message from a first process to a second process hosted on one computer of the distributed system, including passing the message through a shared memory accessible to both the first process and the second process, and passing a second message from the first process to a third process hosted on a second computer of the distributed system, including passing the message over a communication channel coupling the first and the second computers.

Implementations of the invention may include one or more of the following features. The first process uses the same application programming interface to pass the first message and the second message. The first process is unaware of whether the first message and the second message are passing to a process hosted on the first computer or the second computer. A queuing interface is provided for passing messages between computers. A macro queue is provided and configured to be associated with the plurality of queues. The first message is passed from the first process to the second process by calling the application programming interface to initiate a request to the macro queue to obtain a message stored in one of the plurality of queues without identifying a particular queue. The macro queue selects a queue from among the plurality of queues and selects a message from the selected queue. A remote queue proxy is provided for establishing the communication channel between the first and the second computers.

In general, in another aspect, the invention is directed towards a method for message passing in a distributed system by providing a queue manager on each of a group of computers in the distributed system, providing an application programming interface to processes on each of the computers of the group, including providing an interface to accept and to provide messages for passing between processes hosted on the computers, collecting operational statistics at each of the queue managers related to passing of messages between processes using the application programming interface, and optimizing passing of the messages according to the collected statistics.

In general, in another aspect, the invention is directed towards a method for fault-tolerant operation of a system by providing redundant processes for processing messages, providing a separate replicated message queue for each of the redundant processes, accepting a message for processing by each of the redundant processes, enqueuing the message into each of the replicated message queues such that the order of message dequeuing form the queues by the redundant processes is synchronized.

Implementations of the invention may include one or more of the following features. Enqueuing the message into each of the message queues includes performing a logically atomic enqueuing operation on all the queues. Providing each of the replicated queues includes providing a replicated macro queue associated with a plurality of replicated member queues of said macro queue.

In general, in another aspect, the invention is directed towards a method of managing messages by providing an application programming interface (API) to allow a producer module to send a message to a macro queue that manages a plurality of member queues, the API sending the message to the macro queue without identifying one of the plurality of member queues, and using the same API to allow the producer module to send a message to an individual queue.

Implementations of the invention may include one or more of the following features. The macro queue selects one or more of the member queues according to a predefined criteria. The macro queue, the member queues, and the individual queue are implemented as software objects according to object oriented programming principles.

In general, in another aspect, the invention is directed towards a method of managing messages by providing an application programming interface (API) to allow a consumer module to retrieve a message from a macro queue that manages a plurality of member queues, the API retrieving the message from the macro queue without identifying one of the plurality of member queues, and using the same API to allow the consumer module to retrieve a message from an individual queue.

Implementations of the invention may include one or more of the following features. The macro queue selects one of the member queues according to a predefined criteria and selects a message from the selected member queue. The macro queue, the member queues, and the individual queue are implemented as software objects according to object oriented programming principles.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of a distributed system that includes computers connected through a network.

FIG. 2 is a diagram of a local message queuing system that includes a queue manager that manages one or more message queues.

FIG. 3 is a diagram of a local message queuing system that includes a macro queue facility configured as a producer macro queue.

FIG. 4 is a diagram of a local message queuing system that includes a macro queue facility configured as a consumer macro queue.

FIG. 5 is a diagram of two local message queuing systems connected through a network.

FIG. 6 is a diagram of a message queuing system.

FIG. 7 is a diagram of a high level static unified modeling language (UML) class view of the organization of a queue manager.

FIG. 8 is a functional diagram of a queue manager with multiple remote queue proxy objects.

FIG. 9 is a diagram showing the steps for instantiating a QueueManager object and adding a single MessageQueue instance.

FIG. 10 is a diagram showing the steps for creating a macro queue having two MessageQueue instances.

FIG. 11 is a diagram showing the steps for creating RemoteQueueProxy instances to connect to a remote message queue and sending a message to the remote message queue.

FIG. 12 is a diagram showing the steps for configuring a macro queue as a producer queue and the steps for adding a message to a remote queue that is a member of the macro queue.

FIG. 13 is a diagram showing the steps for closing and destructing a remote queue connection.

FIG. 14 is a diagram showing the steps for removing a remote queue proxy from a macro queue.

FIG. 15 is a diagram of an example of a queuing messaging flow for a one-way queue when an EnqueueMsg function is called.

FIG. 16 is a diagram of an example of a queuing messaging flow for a one-way-acknowledged queue when an EnqueueMsg function is called.

FIG. 17 is a diagram showing the queuing message flow for a two-way queue when the EnqueueMsg and the DequeueMsg functions are called.

FIG. 18 is a diagram showing a hash table used by the queue manager to manage a number of lists.

FIG. 19 is a diagram showing how QueueMsg types are linked onto a MessageQueue instance.

FIG. 20 is a diagram of a top level architecture of a Service Core Layer (SCL) core of a wireless communication system.

FIG. 21 is a diagram of a distributed replicated queue pair.

FIG. 22 is a diagram showing a queue replication protocol sequence.

FIG. 23 is a diagram showing a successful replica initiated handoff protocol sequence.

FIG. 24 is a diagram showing a successful master initiated handoff protocol sequence.

FIG. 25 is a diagram showing an unsuccessful replica initiated handoff protocol sequence.

Like reference symbols in the various drawings indicate like elements.

### DETAILED DESCRIPTION

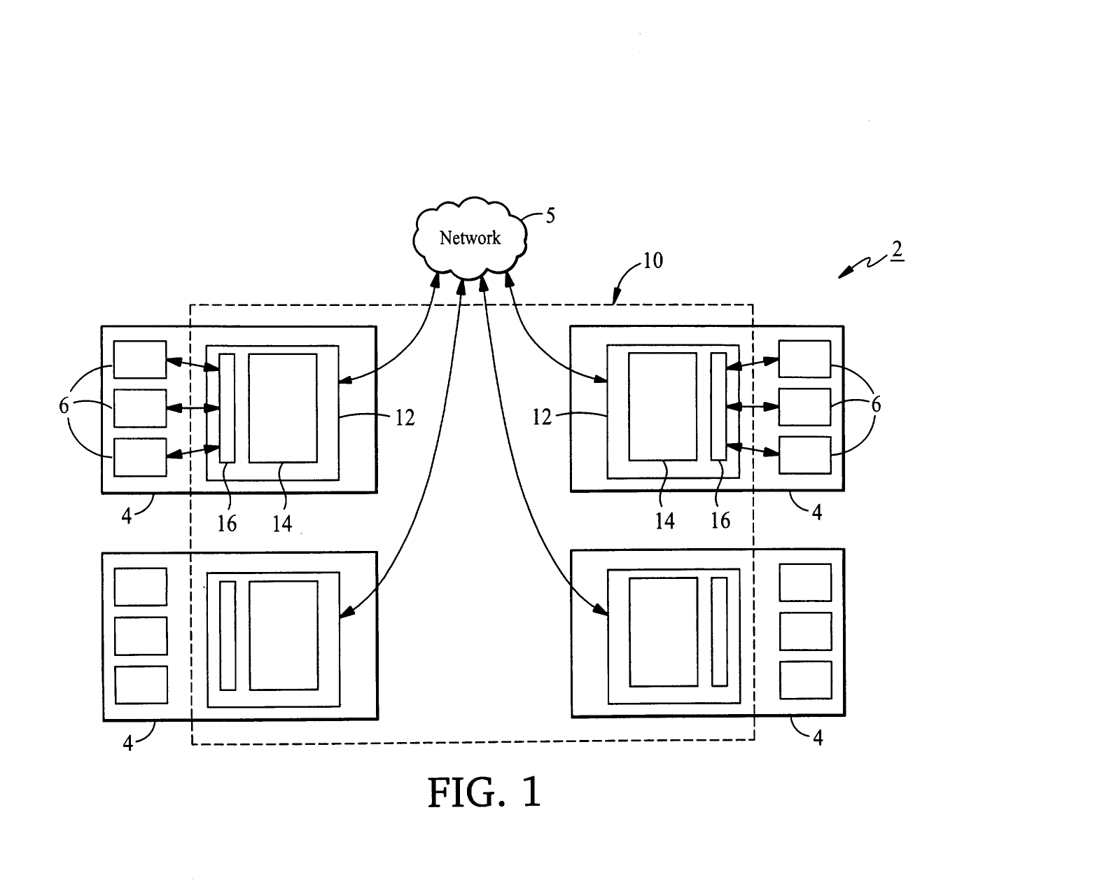

Referring to FIG. 1, a distributed system 2 includes computers 4 that are connected through a network 5. Each computer hosts a number of processes 6. These processes communicate among one another by sending messages. For example, one computer 4 may host processes 6 that send messages through network 5 to processes 6 that are hosted on another computer 4.

The processes pass messages between one another using a message queuing system 10. Message queuing system 10 includes a local queuing system 12 hosted on each of the computers. The local queuing systems provide message communication between processes hosted on the same computer as the local queuing system. In addition, the local queuing systems on different computers interact to provide message communication between processes that are hosted on different computers.

In one version the message queuing system, the computers are separate processors within a telecommunications device, and the network includes a switching fabric that routes messages between the separate processors. In other versions of the system, the computers are client and server computers that are linked by a data network, such as an Ethernet network or a packet-switched network such as the Internet.

Message queuing system 10 supports various types of message queues, such as one-way queues, one-way acknowledged queues, one-way-queued acknowledged queues, and two-way queues. In a one-way queue, the sender does not receive an acknowledgement when the message is received at the destination. In a one-way acknowledged queue, an acknowledgement is sent by the receiver to the sender to indicate that the message has been received. In a one-way queued acknowledged queue, an acknowledgement is given to the sender when the message is successfully stored in a queue. In a two-way queue, when the receiver receives a message, it must send a reply message back to the sender. A reply message contains more information than a mere acknowledgement.

Each local queuing system 12 includes a queue manager 14 that manages the details of the messaging services, and a set of application programming interfaces 16 that provides interfaces between the processes 6 and the local queuing system 12. The queue manager 14 maintains information about the queues in the system and together, the queue managers on the various computers manage detailed operation of the message queuing system 10.

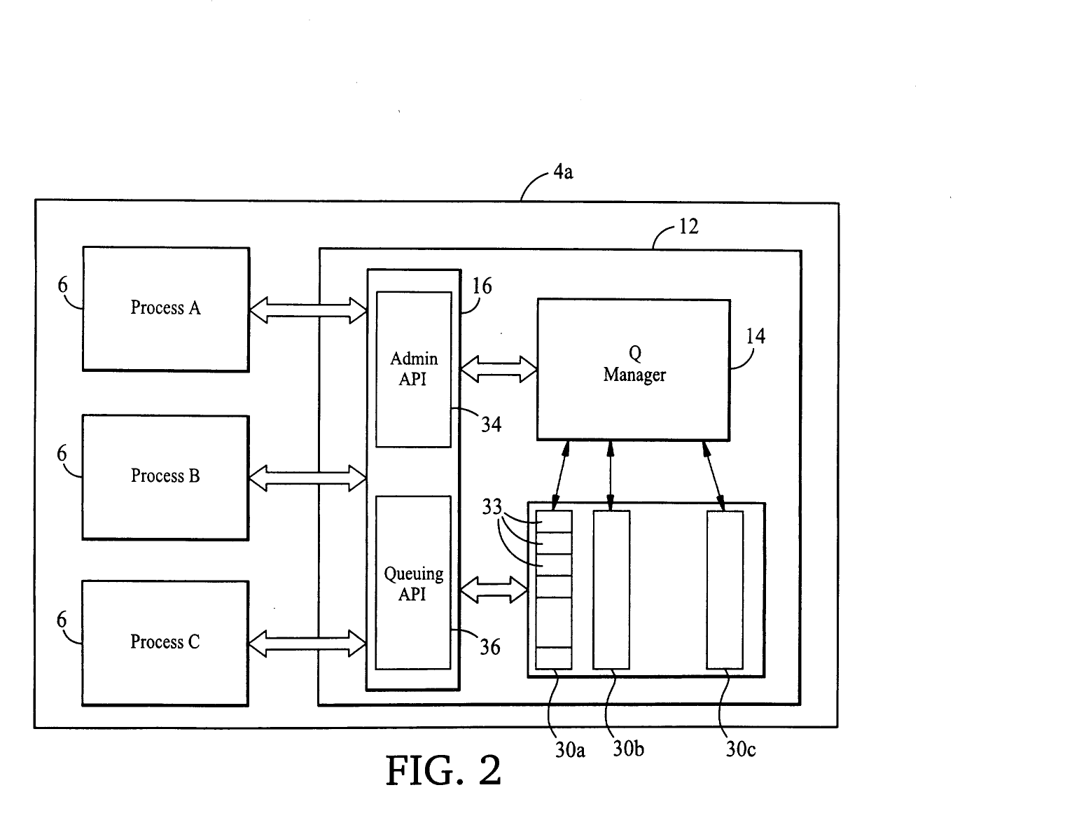

Referring to FIG. 2, local queuing system 12 hosted on a representative computer includes queue manager 14 that manages one or more message queues 30. The message queues 30 are stored in a memory of computer 4 that hosts the local queuing system 12. Each message queue 30 stores queue elements 33 that include messages that are being passed between the processes.

The message queuing system 10 is designed to pass messages with arbitrary payloads between the processes. In the version of the system in which the message queuing system provides communication services between processors in a telecommunications device, the messages may be associated with real-time events, such as a signal that a data packet matching a particular pattern has arrived, or service requests signaling that certain operations need to be rendered.

In operation, as an illustration, process A may initially instruct queue manager 14 to create message queues 30. Once created, a process, such as process B, enables the queue, thereby indicating to queue manager 14 that processes can enqueue and dequeue messages from the queues. When a process needs to use the services of a particular queue, it first sends a request to queue manager 14 to open the queue. Once a process has opened a queue, it can read (dequeue) or write (enqueue) messages to that queue. For example, process B may send messages to all of the message queues 30. Later process C may retrieve messages from selected ones of message queues 30.

The message queues provide an abstraction so that processes can send and retrieve messages in a simplified manner, without necessarily having to deal with the details of the implementation of the queues. For example, when a queue is created, the creator can specify that the queue is a priority queue, such that higher priority messages are dequeued before lower priority messages. The consumer process that retrieves the messages does not have to deal with the prioritization of the messages. Similarly, the producing process does not have to deal with the prioritization, other than specifying a priority for each message.

A process does not have to know about the details of other processes or the details of how the messages are propagated. For example, a process that is sending messages does not need to know whether other processes are ready to receive the messages, nor does a process need to know how the message should be packaged for transmission.

Processes 6 interface with local queuing system 12 through an application programming interface (API) 16. The API 16 includes a set of functions (the administrative API 34) for configuring the queue manager 14, and a set of functions (the queuing API 36) for enqueuing and dequeuing messages. Enqueuing a message involves adding a message to a specified message queue, and dequeuing a message involves removing a message from a specified message queue. The processes may be categorized into three types of clients depending on how the processes interact with the queue manager 14 and the message queues 30: administrative clients, producer clients, and consumer clients. Some processes may fall into more than one of these categories. Administrative clients use the administrative API 34 to create and setup the characteristics and permissions associated with a message queue. Producer clients use the queuing API 36 to add additional requests to a message queue. Consumer clients retrieve messages from the message queues (thereby consuming the queue) and respond to the messages.

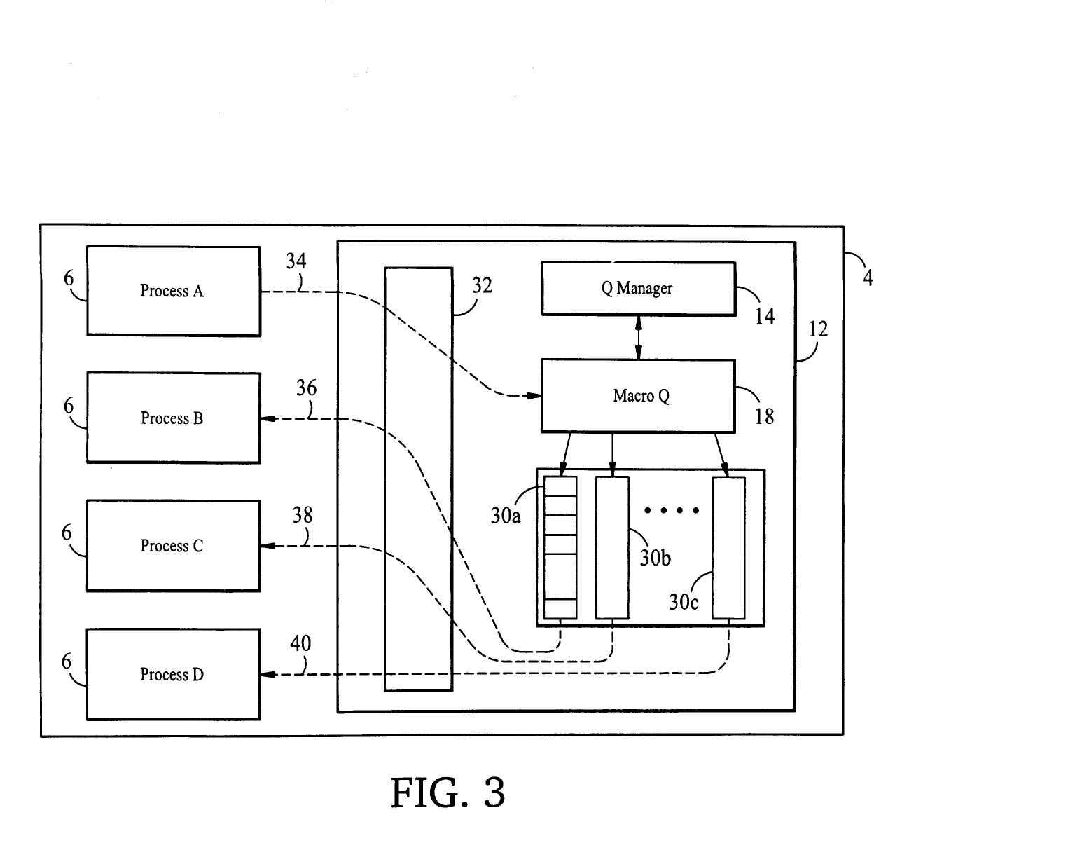

Referring to FIG. 3, message queuing system 10 provides a “macro” queue facility in which an entity is created within the system that has a queue interface that supports enqueuing and dequeuing messages, but that internally manages a set of individual member queues. That is, once created, a macro queue provides an interface to the processes that is essentially identically to an individual queue. Logic regarding how an enqueued message is to be distributed to the member queues, and logic regarding how to dequeue messages from the member queues to satisfy dequeue requests for the macro queue are implemented within message queuing system 10.

As an example, a macro queue 18 groups a number of individual member queues 30. Macro queue 18 allows processes 6 (e.g., processes A-D) a to treat the grouped member queues as a single entity. Macro queues are used to transmit requests to multiple processes or individual processes within a particular process group, or consolidate the requests of multiple processes to a single queue to be serviced by a single process. The individual member queues (e.g., 30a, 30b, 30c) of a macro queue (e.g., 18) may be prioritized relative to one another to provide better or favored service models to select clients.

Processes can configure the macro queue 18 according to a variety of message distribution schemes. For example, a process 6 can configure macro queue 18 as a producer macro queue according to a scheme such that message enqueued to it are enqueued to all member queues, thereby copying the message to each of the member queues. In another scheme, the macro queue enqueues each message into a particular member queue, for example, according to the number of queued messages in the member queues, the average service time for each queue, or in a round-robin fashion. As noted above, the process enqueuing the message is not necessarily aware of the scheme being used for the macro queue, or in fact that the message is being enqueued into a macro queue rather than directly into an individual queue.

In the above example, after the message is enqueued in the macro queue 18, and thereby enqueued in one or more of message queues 30, processes 6 can retrieve the messages from the queues individually. A process 6 is not necessarily aware of the existence of the macro queue or the number of member queues or the conditions of the member queues. Similarly, process 6 does not necessarily know which process will be consuming the messages. As shown in dotted lines 36, 38, 40, in this example, processes 6 dequeue messages from message queues 30 without necessarily knowing which process had sent the message.

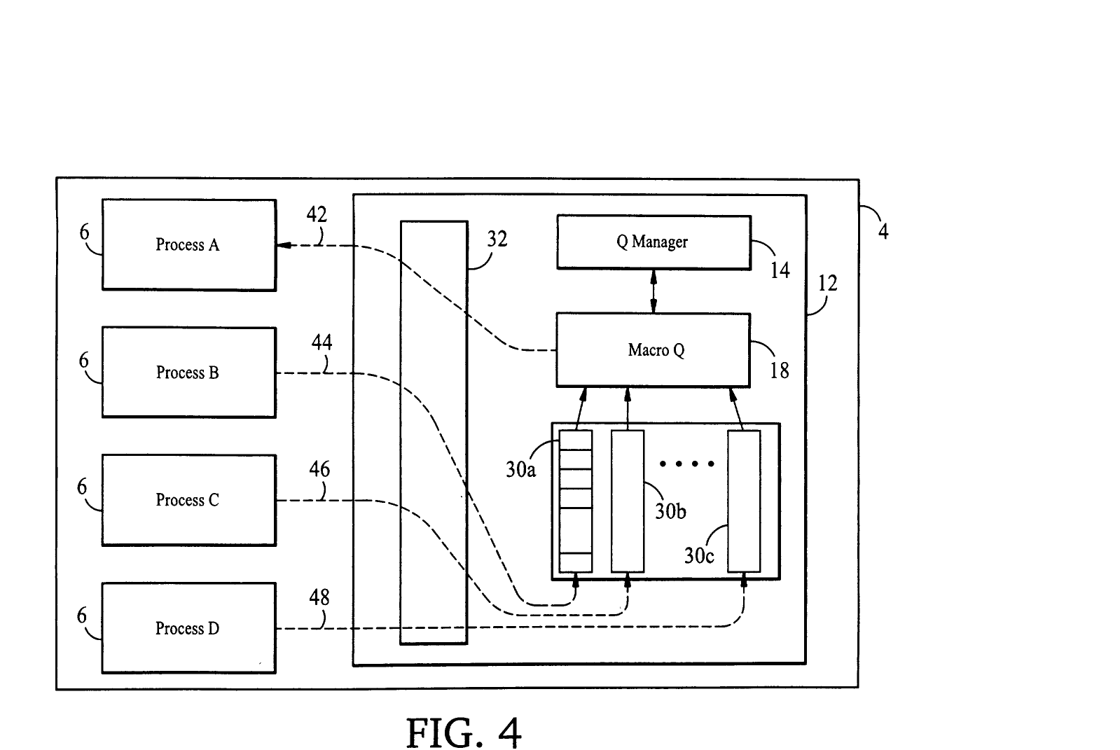

Referring to FIG. 4, process 6a can also configure macro queue 18 as a consumer macro queue that retrieves messages for its member queues. When process 6 requests to dequeue a message from the macro queue 18, a message from one of the member queues is dequeued to satisfy the request. The particular message that is dequeued is based on the scheme that is set when the macro queue 18 was created. For example, the message can be selected based on priorities of the member queues, priorities of the messages in the queues, or in a round-robin order such that messages are dequeued from each of the member queues in turn. As shown in dotted line 42, process 6 can retrieve a message from the macro queue 18 in the same way as retrieving a message from a single queue. Process 6 does not necessarily know the number of member queues nor the conditions of the member queues (e.g., whether a message queue is ready to send messages). Process 6 does not necessarily know which process will be sending the messages and wait for the messages from those processes. In this example, the messages are enqueued in the message queues 30 by processes 6 individually. As shown in dotted lines 44, 46, 48, processes 6 enqueue messages to particular message queues 30 without knowing which process will be consuming the message.

Message queuing system 10 also supports message passing between processes on different computers. When a process creates a queue, it can indicate to the queue manager that the queue is accessible to processes on other computers, and specifies an IP port number at which messages for that queue can be received. Another process on another computer can then open the queue by specifying the IP address (host and port number) of the remote queue.

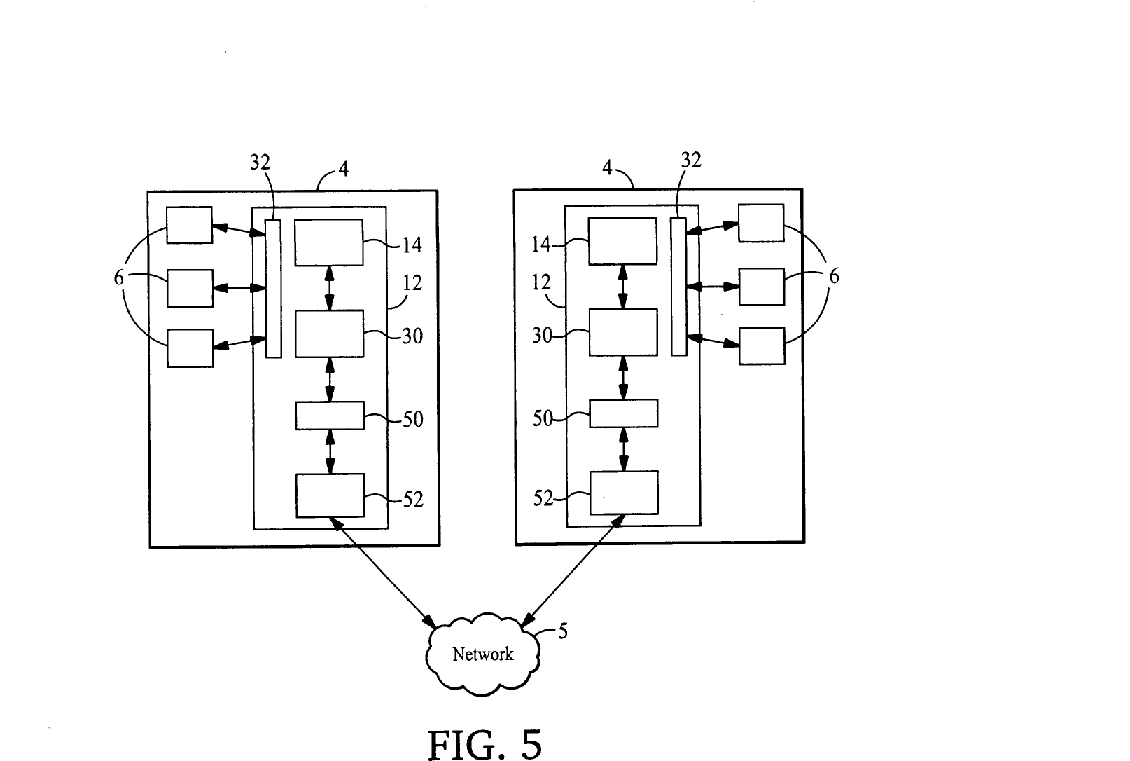

Referring to FIG. 5, a message queue 30 can be accessed by local processes 6 hosted on the same computer 4, or be accessed by remote message processes 6. Local processes access the data stored in the message queue 30 directly, while remote processes require that an inter-process communication (IPC) mechanism be employed. In either case, the process enqueues and dequeues messages in the same manner independent of whether the message queue is located locally or at a remote location. Each local queuing system 12 implements a remote queue proxy 50 which uses a TCP communication protocol stack 52 to allow a remote process to access a local message queue. The remote queue proxy 50 acts as a “listener” to accept requests for enqueuing or dequeuing messages across the network. At a remote computer, a queue proxy 50 packages the messages into a form suitable for transport across communication stack 52 and network 5. A request from a remote process is “marshaled” into a request message that is transported across an address space bound to the address space where the message queue resides. Upon arrival, the packed request is “un-marshaled” and the specified API call is made using the parameters specified by the initiating remote process.

The member queues of a macro queue may be located outside of computer 4a and has to be accessed over network 5. Referring back to FIG. 3, macro queue 18 takes care of the network protocols, so when process 6a distributes messages over a network, process 6a does not need to know the details of the network 5. By using macro queue 18 to handle the distribution of the message to the member queues according to a predefined distribution scheme, processes can distribute messages to multiple message queues in a simple manner.

Implementation of Message Queuing System

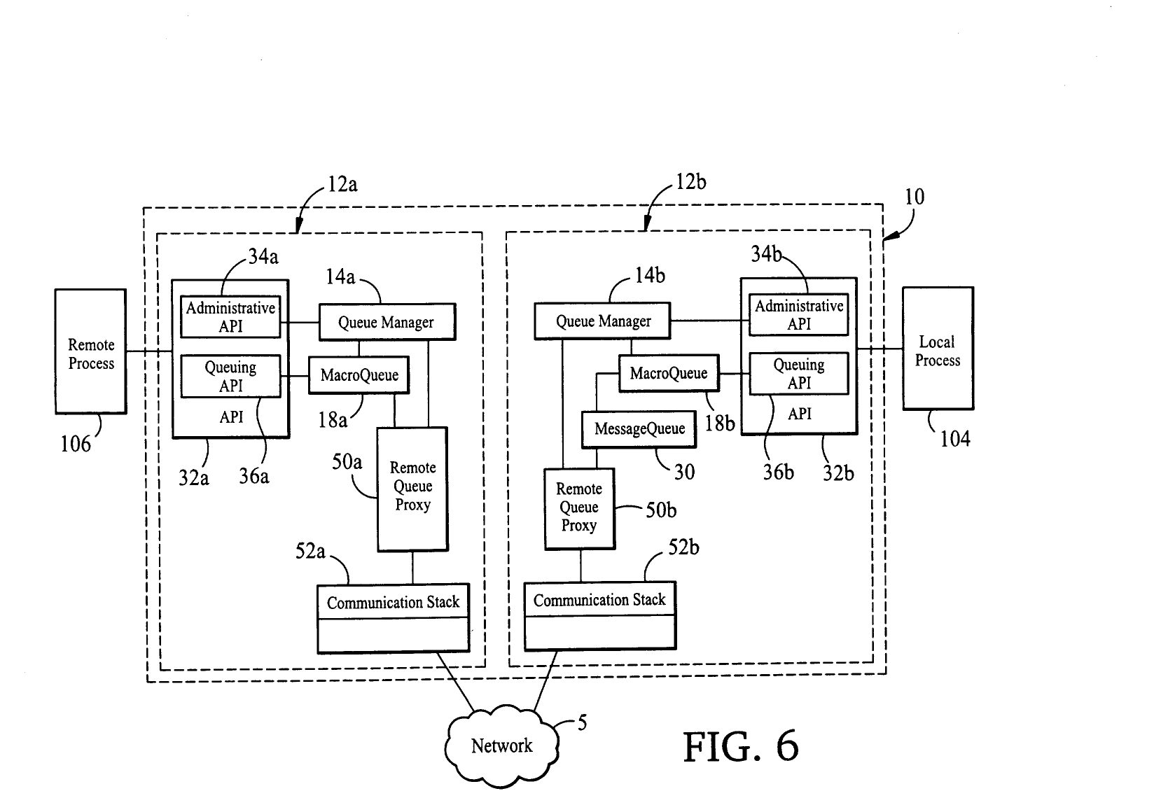

Referring to FIG. 6, message queuing system 10 is implemented based on object oriented programming principles. A set of object classes that include QueueManager, MessageQueue, RemoteQueueProxy (abbreviated as RemoteQProxy), MacroQueue, and BaseQueue classes are used to implement a queuing system that supports one-way queues, one-way acknowledged queues, one-way-queued acknowledged queues, and two-way queues. Software producer processes send (or produce) messages to the queues, and software consumer processes remove (or consume) messages from the queues. The processes can be local or remote.

APIs allow the processes to easily access messages in local and remote queues without regard to the details of queue implementation or the transmission protocols used for network 5. Queue replication is provided with automatic queue state replication to ensure fault tolerance. A macro queue allows software processes to access a group of message queues as a single entity, thus allowing complex queuing networks to be built without requiring the processes to manage and schedule service for large numbers of queues.

Message queue 30 stores messages sent from a local process 104 or a remote process 106. The local process 104 sends messages to message queue 30 directly. The remote process 106 sends messages to the message queue 30 over network 5 through remote queue proxies 50a, 50b. A macro queue 18b is constructed and associated with message queue 30 and additional message queues (now shown) so that an API 32b can access the message queues as if accessing a single queue. Likewise, a macro queue 18a is constructed and associated with message queues (e.g., message queue 30) so that an API 32a can access the message queues as if accessing a single queue.

Queue managers 14a, 14b are instances of a QueueManager class. Macro queues 18a, 18b are instances of a MacroQueue class. Message queue 30 is an instance of a MessageQueue class, and remote queue proxies 50a, 50b are instances of a RemoteQProxy class. In the description below, the terms “message queue,” “message queue object,” and “MessageQueue instance” are used interchangeably. Likewise, the terms “macro queue” and “macro queue object” are interchangeable with “MacroQueue instance,” and so forth.

A queue manager object is instantiated when a messaging scheme between two software processes or within a single software process is implemented. As an example, queue manager 14b manages message queue 30, remote queue proxy 50b, macro queue 18b, and acts as a coordinator of the queuing mechanism. Queue manager 14b has default options that can be modified by an administrative API 34b. Administrative API 34b provides an interface to create, destroy, activate/deactivate, instances of MessageQueue, RemoteQueueProxy, and MacroQueue classes. Administrative API 34 is also used to set the permission levels and features of the MessageQueue, RemoteQueueProxy, and MacroQueue instances. A queuing API 36b is used to enqueue and dequeue messages to the message queue 30.

To pass messages between local process 104 and remote process 106, local process 104 calls a CreateQueueInstance (abbreviated CreateQInstance) function and passes an argument “Actual” to create an “actual” instance of the MessageQueue class, which becomes the message queue object 30. (Note: according to object oriented programming terminology, the CreateQInstance function would be called a “method” that is associated with the queue manager “object.” The term “function” is used here instead of “method.”) A unique name, IP address, and port number is assigned to the message queue object 30. When a remote process 106 intends to make a connection to message queue 30, the remote process 106 looks up an LADP database (not shown) to find the name, IP address, and port number of the message queue 30 and calls the appropriate API to create remote queue proxies 50a-b and communication stacks 52a-b. The communication stacks 52a-b serve as interfaces between the remote queue proxies 50a-b and the network 5. Note that when a process and a message queue are hosted different computers, the process is considered to be remote with respect to message queue. In some implementations, a computer may allocate different address spaces to different processes, with each process running independent of each other. In such implementations, when a process and a message queue are located in different address spaces, the process is also considered to be remote with respect to the message queue.

Message queue 30 is created through the queue manager 14b using the CreateQInstance function. When the CreateQInstance function is called, it creates a message queue object and returns an instance pointer of the message queue object. The instance pointer is used by functions associated with the message queue object to locate the message queue. A QueueConfigure function is used to configure the message queue 30. A QueueOpen function is used to open the message queue 30. A message queue must be created and opened before any other process can establish a connection to the message queue. Once a message queue is opened, messages can be enqueued and dequeued from it.

Local process 104 can access message queue 30 through a DequeueMessage (abbreviated as DequeueMsg) function and an EnqueueMesssage (abbreviated as EnqueueMsg) function.

Remote process 106 can access message queue 30 by first constructing a queue manager 14a, then calling the CreateQInstance function, passing an argument Remote_Proxy to create the remote queue proxy object 50a. A unique name, IP address, and port number is assigned to the remote queue proxy 50a. The remote process 106 then calls the QueueOpen function to create a communication stack 52a. A TCP connection is made to the IP address and port that was specified when the remote queue proxy 50a was created. If the message queue 30 options are set to allow remote clients, then remote queue proxy 50b and communication stack 52b are created. Messages are exchanged between remote queue proxies 50a and 50b to configure and open the message queue 30. The queue name and address are looked up from the LDAP database so that the remote queue proxy 50b can find the message queue 30. When remote queue proxy 50b finds message queue 30, the remote queue proxy 50b sends an acknowledgement to remote queue proxy 50a to indicate a successful attachment.

The remote process 106 uses the EnqueueMsg function to send messages to message queue 30. This is achieved by creating a QueueMessage instance locally and propagating the QueueMessage instance through communication stacks 52a-b and network 5 to message queue 30. When the QueueMessage instance propagates to message queue 30, the message in the QueueMessage instance is added to message queue 30. The local process 104 then calls the DequeueMsg function of message queue 30 to retrieve the message off the message queue.

One queue manager object (e.g., 14a, 14b) is created for each software process. Each queue manager can create multiple instances of the MessageQueue class. As an example, after queue manager 14a is configured, a MacroQueue instance 18a can be created by calling a CreateMacroQueueInstance (abbreviated CreateMacroQInstance) function. This will return a MacroQueue instance pointer that can be recognized by the same queuing API used to create the individual queues. The queuing API may call the EnqueueMsg function to add a message to macro queue 18a, or call a DequeueMsg function to retrieve a message from macro queue 18a. Macro queue 18a communicates to all of the individual queues to enqueue and dequeue messages. Different options can be set for the macro queue 18a to determine how messages are added or removed from each individual queue associated with the macro queue 18a. By associating several related message queues with a single macro queue, the API used to interact with the message queues can be simplified.

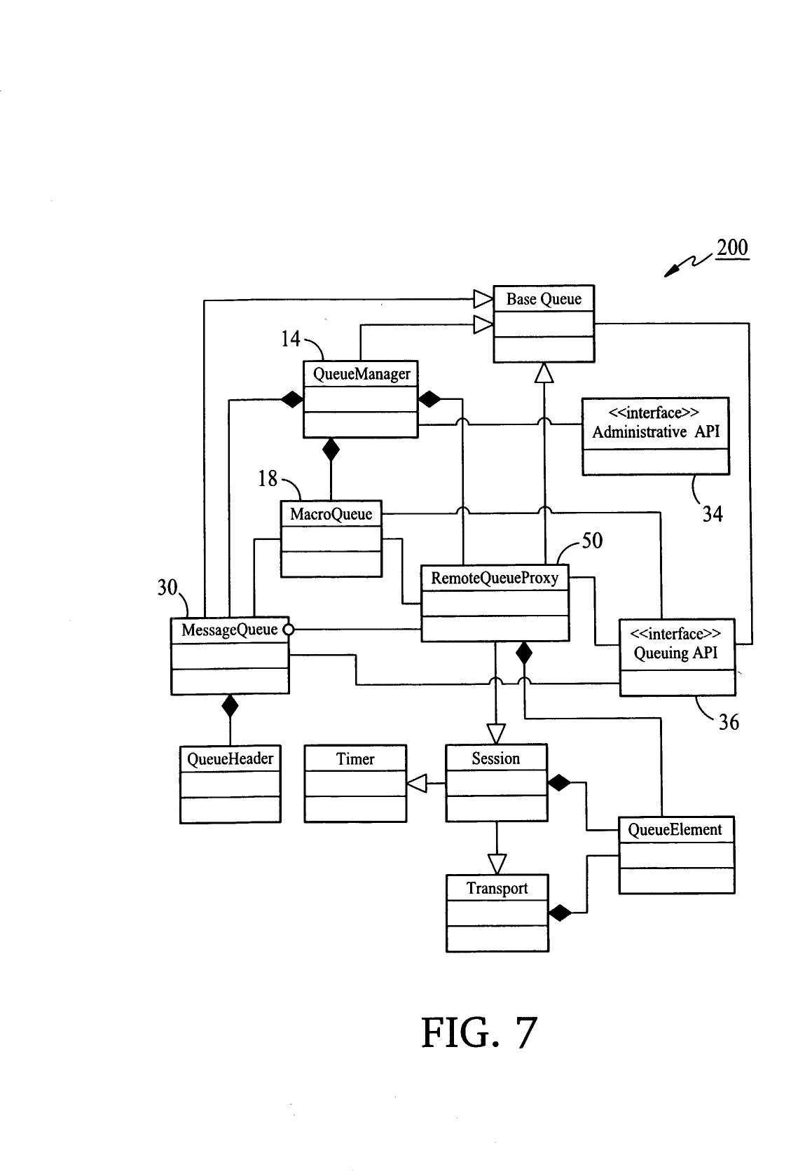

FIG. 7 is a diagram of a high level static unified modeling language (UML) class view 200 of the organization of a queue manager. The administrative API 34 interfaces with the QueueManager class 14, and the queuing API 36 interfaces with the MacroQueue 18, MessageQueue 30, and RemoteQueueProxy 50 classes. This shows the inheritance structure of the various software objects.

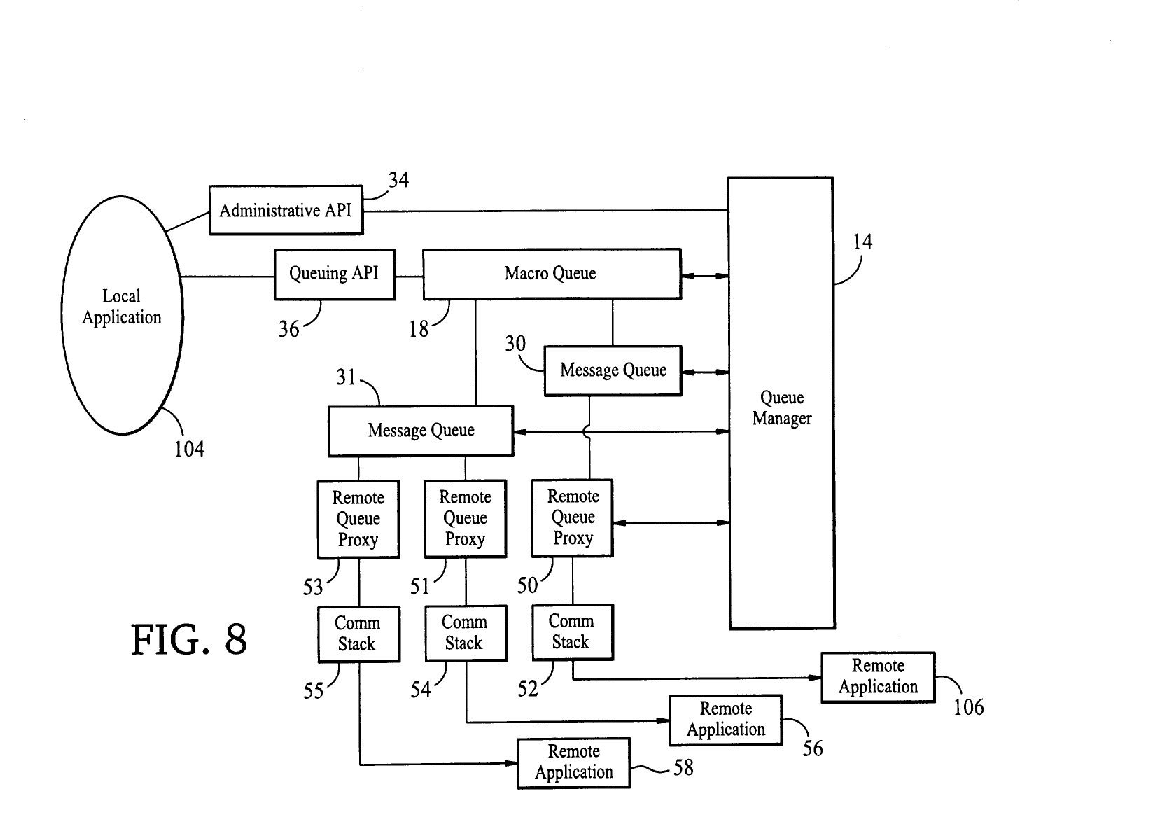

FIG. 8 is a functional diagram of a queue manager 14 with multiple remote queue proxy objects 50, 51, 53. The queue manager 14 calls the CreateMacroQInstance function to create macro queue 18. Next, queue manager 14 calls the CreateQInstance function to create the message queues 30 and 31. Next, queue manager 14 calls an AddMacroQMemberInstance function to associate message queues 30 and 31 with macro queue 18. Queue manager 14 sets remote options of the message queues 30, 31 to indicate that remote connections are allowed and that a server (not shown) is required. When a remote process 106 accesses message queue 30, the remote queue proxy 50 and the communication stack 52 is created. When a second remote process 56 accesses message queue 31, another communication stack 54 is created. Likewise, when a third remote process 58 accesses message queue 31, a communication stack 55 is created. Each communication stack includes a SessionProtocol instance and a TransportProtocol instance that are connected through TCP sockets to the remote process. The remote processes can be either producers or consumers.

QueueManager Class

Processes may create and configure various objects of the QueueManager class. The administrative API 34 creates an instance of the QueueManager class for each process. The administrative API 34 is used to configure a QueueManager instance (e.g., 14). The administrative API 34 calls functions associated with the queue manager 14 to create instances of a BaseQueue class, which includes the MessageQueue and RemoteQProxy classes. The administrative API 126 then creates a hash table of the various MessageQueue and RemoteQProxy instances that the queue manager 14 is managing. When message queues (e.g., 30, 31) are created, they inherit the configuration of the queue manager 14. The administrative API 34 are also used to change the configuration of the individual message queues. A local process and a remote process will use the same API to access message queue 30.

Table 1 lists the functions that can be used to configure a MessageQueue instance. Table 2 shows the possible options of the parameters used for each function. These functions and parameter options are given as examples; other functions and parameter options may be used. The options are stored in memory after configuration is completed. When instances of the MessageQueue and MacroQueue classes are created, the same options are copied over to those instances.

TABLE 1

| Name of software function | Description of the software function |
|---|---|
| SetQueueModel | This function sets the queuing model associated with a |
| (Queue_Manager_Model) | MessageQueue instance. |
| SetQueueRelationship | This function is relevant to remote queue proxies only. |
| (Queue_Manager_Queue_Relationship) | It is used to set options for a remote queue proxy to |
| | determine whether it is a consumer or producer of the |
| | message queue. |
| SetConsumerOptions | This is relevant to macro queues only. If the |
| (Queue_Manager_Consumer_Options) | “Prioritized” option is selected, all queues are emptied |
| | in priority order. A higher priority queue is emptied |
| | before a lower priority queue. If the “Chronologically” |
| | option is selected, messages are dequeued in the order |
| | that they arrive. |
| SetProducerOptions | This is relevant to macro queues only. If the |
| (Queue_Manager_Producer_Options) | “First_Available” option is selected, messages will be |
| | enqueued at the first message queue available. If the |
| | “Round_Robin” option is selected, message will be |
| | sent to each queue in a cycling manner regardless of |
| | load conditions. |
| SetServerRequired (Boolean) | This applies to the MessageQueue class only. The |
| | Boolean value determines whether this queue is set up |
| | as a TCP server. |
| SetQueueReplication (Boolean) | This applies to the MessageQueue class only. The |
| | Boolean value determines whether this queue will be |
| | replicated. |
| SetMaxQueueDepth (Integer) | This function sets the maximum allowed messages in a |
| | queue. Once the limit is reached and another message |
| | is to be Enqueued, an error response is returned. |
| SetRemoteClientsAllowed (Boolean) | This Boolean value determines whether remote clients |
| | are allowed to attach. |

TABLE 2

| Parameter name | Possible options for the parameter |
|---|---|
| Queue_Type | Actual, Remote_Proxy, Local_Proxy |
| Queue_Manager_Queue_Model | One_Way, One_Way_Acknowledged, Two_Way |
| Queue_Manager_Queue_Relationship | Consumer, Producer |
| Queue_Manager_Consumer_Options | Prioritized, Chronologically |
| Queue Manager_Producer_Options | First_Available, Round_Robin |

Table 3 lists the software functions used to determine which options are selected for the parameters of the QueueManager class.

TABLE 3

| Software function name | Purpose of the software function |
|---|---|
| GetQueueModel ( ) | Returns the option that is selected for the |
| | Queue_Manager_Queue_Model parameter |
| GetQueueRelationship ( ) | Returns the option that is selected for the |
| | Queue_Manager_Queue_Relationship parameter |
| GetConsumerOptions ( ); | Returns the option that is selected for the |
| | Queue_Manager_Consumer_Options parameter |
| GetProducerOptions ( ); | Returns the option that is selected for the |
| | Queue_Manager_Producer_Options parameter |
| GetServerRequired ( ); | Returns a Boolean value representing whether a server is |
| | required. |
| GetQueueReplication ( ) | Returns a Boolean value representing whether the queue is |
| | replicated |
| GetMaxQueueDepth ( ); | Returns an Integer value representing the maximum queue |
| | depth |
| GetRemoteClientsAllowed ( ); | Returns the Boolean value representing whether remote |
| | clients are allowed |
| GetQueueType ( ); | Returns the option that is selected for the Queue_Type |
| | parameter |

Table 4 lists the software functions that can be used to control the QueueManager class during run-time.

TABLE 4

| Name of software function | Purpose of the software function |
|---|---|
| CreateQInstance (Queue_Type) | This creates the appropriate instance of the BaseQueue class |
| | depending upon the Queue_Type parameter. If the parameter |
| | is set to “Actual,” an instance of the MessageQueue class is |
| | created. If the parameter is set to “Remote_Proxy,” then an |
| | instance of the RemoteQueueProxy class with the |
| | communications stack is created. |
| DestroyQueueInstance | This cleans up the memory and links associated with the |
| (BaseQueue) | message queue, including bindings with the macro queue and |
| | the remote connections. The message queue is removed from |
| | the QueueManager's hash list and is deleted. All messages |
| | currently in the queue are removed. |
| CreateMacroQueueInstance ( ); | This creates a macro queue instance and returns a pointer to |
| | it. The pointer is stored as a list of members in the |
| | QueueManager class (??). |
| DestroyMacroQueueInstance | This cleans up the MacroQueue instance and all of the |
| (MacroQueue) | MessageQueue instances associated with it. |
| QueueConfigure ( ) | This signals the end of the configuration phase and engages |
| | the configuration that has been set. |
| QueueOpen ( ) | This opens the queue and enables it for subsequent calls for |
| | MessageQueue and MacroQueue creation. At this point no |
| | more configuration can be done for the QueueManager. |
| QueueClose ( ) | This cleans up all data members (MessageQueue, |
| | MacroQueue, RemoteQueueProxy instances) associated with |
| | the queue manager. |
| QueueStats | This returns the following structure: |
| (Queue_Manager_Stats); | Typedef struct |
| | { |

| | |
|---|---|
| UINT state; | //Operational state of the |

master queue

| | |
|---|---|
| UINT NumMacroQueues; | //Number of the Macro |

Queues created

| | |
|---|---|
| UINT NumMessageQueues; | //Number of Actual |

Queues created

| | |
|---|---|
| UINT NumRemoteClients; | //Number of Remote |

| | Queues |
|---|---|
| | } Queue_Manager_Stats; |
| CreateReplicatedQueueInstance ( ); | This creates a queue that is replicated. The replicated queue |
| | may be used by another process or by the same process. |
| DestroyReplicatedQueueInstance | This cleans up all data associated with the queue and calls the |
| (BaseQueue); | destructor. |

Table 5 lists the default options for QueueManager parameters.

TABLE 5

| Parameter name | Default option |
|---|---|
| Queue_Model | One_Way |
| Server_Required | True |
| Remote_Clients_Allowed | True |
| Queue_Depth | 1000 |
| Consumer_Options | Prioritized |
| Producer_Options | First_Available |

BaseQueue Class

The BaseQueue class is the base class for the other queue classes, such as MessageQueue class and RemoteQueueProxy class. The API configures the options of the BaseQueue class, the options are then passed on to child classes that are based on the BaseQueue class so that the derived classes are abstracted from the interface side of it and solidifies a consistent mechanism to the process and queue manager code.

MessageQueue Class

The MessageQueue class inherits the functionality of the BaseQueue class. It's primary purpose is to hold an actual message queue QueueHeader class that links the messages together. Instances of the MessageQueue class is created using the CreateQInstance function of the QueueManager class or the AddMacroQeuueMemberInstance of the MacroQueue class. When an instance of the MessageQueue class is constructed, it will copy the configuration options from the QueueManager. A process can modify the parameters by calling appropriate functions to configure the individual MessageQueue instance. An MessageQueue instance is uniquely identified in the system by its name that is assigned at configuration time when the LDAP request has occurred.

The MessageQueue class contains a list of pointers to the RemoteQueueProxy objects. This allows multiple remote connections to the same MessageQueue instance. The session and transport that is created to connect to this MessageQueue instance on the queue side of the interface is set up at the server side. All client connections to the queue must bind dynamically by looking up the queue name in the QueueOpen and binding it to the ActuaIQ instance. This binding is done through a pointer.

All of the configuration functions described in relation to the QueueManager class can be used to configure the MessageQueue class. In addition, the MessageQueue class can be configured using the functions listed in Table 6.

TABLE 6

| Name of software function | Purpose of software function |
|---|---|
| SetQueueAddress (const | This function sets the name and server address of the |
| char Host_Name, const | MessageQueue instance that remote clients can attach to. A unique |
| char Address, short Port) | TCP server is set up for each MessageQueue instance. |
| GetQueueAddress (char | This function returns the name and sever address of the |
| Host_Name, char | MessageQueue instance. |
| IP_Address, short Port) | |
| GetStats | This function returns the following queue statistics: |
| (Actual_Queue_Stats) | Typedef struct |
| | { |

| QUEUE_STATE state; | |
|---|---|
| Int Current_Messages_Queued; | |
| Int Total_Messages_Queued; | //Count of all |

messages ever queued here

Int Average_Queue_Process_Time;
Int Highest_Queue_Depth;
Int Configred_Queue_Depth;
Int Number_Of_Remote_Clients;
Int Number_Of_Consumer_Clients;
Int Number_Of_Producer_Clients;

} Actual_Queue_Stats

Table 7 lists the functions used to control the MessageQueue class.

TABLE 7

| Name of software | |
|---|---|
| function | Purpose of software function |
| QueueConfigure ( ) | Signals the end of the configuration phase and |
| | engages the configuration that's been set. Sets |
| | the queue state to “Configured.” |
| QueueOpen ( ) | This opens the queue and enables it remote |
| | client attachment, and local enqueue and |
| | dequeue of messages. Sets the queue state to |
| | “Open.” |
| QueueClose ( ) | This function closes all RemoteQueueProxy |
| | clients attached, and frees up all messages in |
| | the queue. Sets the queue state to “Closed.” |

Table 8 lists the software functions used to enqueue and dequeue messages.

TABLE 8

| | |
|---|---|
| EnqueueMsg (QueueMessage, | This is called by C++ programs that have inherited |
| TimeToBlock) or | the QueueMessage class in their declaration of |
| EnqueueMsg (QueueMessage) | message objects. In the QueueMessage class will |
| | be a “char *” to a data buffer and a length that was |
| | set up when the object was created. The |
| | TimeToBlock field is used to indicate how long to |
| | block waiting for a response from the other side. −1 |
| | indicates forever, 0 will return right away. The |
| | units use the timestruc_t structure so values can be |
| | set for nanosecond granularity. The TimeToBlock |
| | parameter is only used when the queue type is |
| | One_Way_Acknowledged or Two_Way. If the |
| | second form is used then the call will block forever, |
| | until an acknowledgment happens for the |
| | One_Way_Acknowledged and Two_Way queues. |
| DequeueMsg ( ) | This function will signal the MacroQueue, |
| | MessageQueue or RemoteQueueProxy that the |
| | calling process is waiting for a message. A |
| | message handle is returned that will be passed in an |
| | argument to the QueueCompletionRoutine later. |
| | This allows multiple messages to be dequeued in |
| | advance so the message processing loop can run |
| | more efficiently. The TimeToBlock indicate how |
| | long to wait for a message. |
| DequeueMsg (TimeToBlock) | This function will signal the MacroQueue, |
| | MessageQueue or RemoteQueueProxy that the |
| | calling process is waiting for a message. This |
| | function will assert if the TimeToBlock parameter is |
| | 0. It is designed to wait for a message. |
| CheckMessageCompletion | This is used to check on the status of a message that |
| (Message_Handle, QueueMessage) | has been enqueued. It will return RTNvalTrue, |
| | RTNvalFalse, or RTNvalInvalid_Handle. If |
| | RTNvalTrue then the QueueMessage pointer will |
| | hold the pointer to the QueueMessage instance. |
| void (MessageCompletedFP) | This is a function pointer that is called when the |
| (Message_Handle, QueueMessage) | acknowledgment to an EnqueueMsg function is |
| | received. It passes the message handle and the |
| | pointer to the acknowledged QueueMessage itself. |
| | This is called from the RemoteQueueProxy or the |
| | MessageQueue class. It is used for the |
| | One_Way_Acknowledge and the Two_Way queues. |
| SendReply (Message_Handle) | This function is used for the Two_Way queue only. |
| | It sends the Message_Handle to the class it is |
| | talking to, to propagate an acknowledgement back |
| | to the remote side. The remote side keeps a copy of |
| | the message and passes the message back to the |
| | calling task using the MessageCompletedFP |
| | function. |

RemoteQProxy Class

The RemoteQProxy class has a master instance that is created when the QueueManager executes the QueueConfigure function, if the RemoteClients option is set to “True.” This calls a different constructor for the SessionProtocol and the TransportProtocol classes. It will create a thread whose sole purpose is to sit on a socket “select” call and process read, write and exception events. This will be managed by the TransportProtocol layer and will be discussed in the TransportProtocol design specification. This master instance will exist on both processes.

Instances of the RemoteQProxy class may be created in several ways. The CreateQInstance (Remote_Proxy) function is usually invoked when done in a separate process space than the MessageQueue. The constructors for the SessionProtocol and the TransportProtocol will automatically be called when it is created. The BaseQueue that the RemoteQProxy was inherited from, will be linked onto the QueueManager hash table. The options are configured including the SetQueueAddress, the queue is opened through the QueueOpen function. This sends the client connection (SessionOpen, TransportOpen) to the remote side where the queue resides. When the server side does the socket “accept” call, the CreateNewConnection function is called which is a virtual that calls up to the RemoteQProxy layer and constructs the stack, from the most derived class, RemoteQProxy, down to the TransportProtocol. A queuing protocol is used to indicate the options for the queue. These will come encapsulated in a RemoteQProxy_Open_Request message. The options include the name, IP address, and port number of the queue, as well as the queue type. These options are validated against the existing parameters of the queue. The queue side RemoteQProxy calls into a static function BindToQueue with parameters of the name, IP Address and port. The result is that a queue instance pointer that is stored in the queue side RemoteQProxy. This is what is used to call EnqueueMsg and DequeueMsg on behalf of the remote side.

The queuing API commands used for the MessageQueue class can also be used for the RemoteQProxy class.

MacroQueue Class

Macro queues allow a single interface to be used for the processes while communicating to multiple queues “behind the scenes”. The process can define a macro queue that is a front end to the child queue instances, whether they are MessageQueue instances or RemoteQProxy instances. This allows a single, clean interface for the run-time aspect of the execution. Each macro queue must be set up to be either a consumer or producer using the SetQueueRelationship function. The default option will be consumer and is applied to all subsequent MessageQueue instances created through the macro queue using the AddMacroQMemberInstance function. Since the queues can be configured separately, once the QueueConfigure function is called for the macro queue, a validation routine will cycle through the list of MessageQueue instances under the macro queue's control to verify that all of the configured options are compatible. For example, setting up a macro queue to be a producer and configuring the RemoteQProxy instances to be consumers will not be compatible, and an error return code will be returned.

Table 9 lists the functions that can be used to set the macro queue options.

TABLE 9

| Name of software function | Purpose of the software function |
|---|---|
| SetConsumerOptions | This is relevant to macro queues only. If the |
| (Queue_Manager_Consumer_Options); | option “Prioritized” is used, all queues will be |
| | emptied in priority order. The highest priority |
| | queues will be emptied before the lowest |
| | priority queues. If the option |
| | “Chronologically” is used, messages will be |
| | dequeued in the order that they arrive. |
| SetProducerOptions | This is relevant to MacroQueue instances only. |
| (Queue_Manager_Producer_Options) | In the option “First_Available” is used, the |
| | messages will be enqueued at the first queue |
| | without pending waits on it. If the option |
| | “Round Robin” is used, the messages will be |
| | sent to each queue in a round robin fashion that |
| | cycles through each queue regardless of load |
| | condition. |
| AddMacroQueueMemberInstance | This calls the CreateQInstance function of the |
| (Queue_Type, Queue_Priority) | QueueManager class but also includes the |
| | priority of the queue. Priorities range from 1 |
| | to 100, where 100 represents the highest |
| | priority. The priority values will be used if the |
| | MacroQueue is set up to use the consumer |
| | option of “Prioritized.” |
| RemoveMacroQueueMemberInstance | This removes the MessageQueue instance by |
| (BaseQueue) | calling the DestroyQueueInstance function of |
| | the QueueManager. The MessageQueue |
| | instance is freed from the control from the |
| | MacroQueue. |

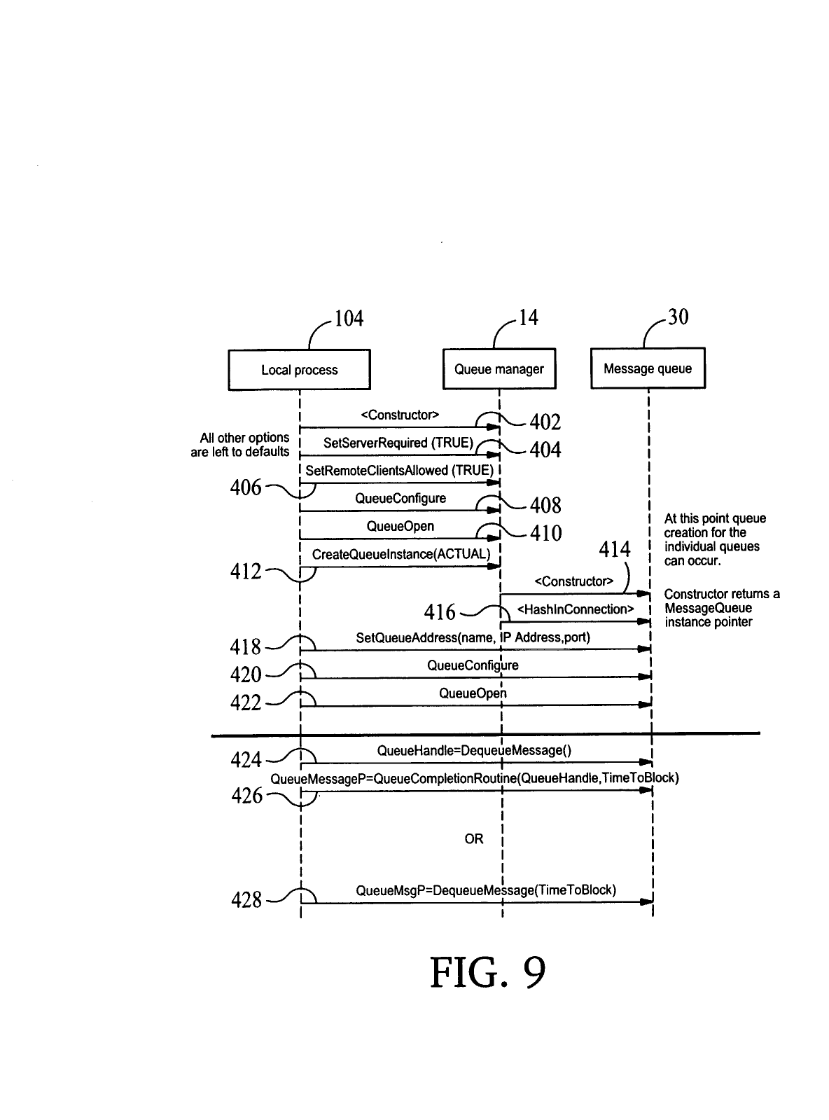

FIG. 9 is a diagram showing the steps for creating a QueueManager instance 14 and adding a single MessageQueue instance 30. In step 402, the local process 104 calls a constructor of the Queue Manager class to create a queue manager object 14. In step 404, process 104 calls a SetServerRequired function to specify that a server is required. In step 406, process 104 calls a SetRemoteClientsAllowed function to specify remote clients are allowed. In step 408, process 104 calls a QueueConfigure function to configure the queue manager 14. In step 410, process 104 calls the QueueOpen function to open the queue manager 14. At this point, the queue manager 14 has been configured so that individual queues can be created.

The following shows how a new message queue is created. In step 412, process 104 calls the CreateQInstance function to instruct the queue manager 14 to create an instance of the MessageQueue class. In step 414, the queue manager 14 calls a constructor to create a message queue 30. In step 416, the constructor returns a MessageQueue instance pointer. In step 418, process 104 calls a SetQueueAddress function to set the name, IP address, and port number for the newly created message queue 30. In the figure, process 104 only configures the address option of the message queue 30. Other options of the message queue 30 can also be set. In step 420, process 104 calls the QueueConfigure function to configure the message queue 30. In step 422, process 104 calls the QueueOpen function to open the message queue 30.

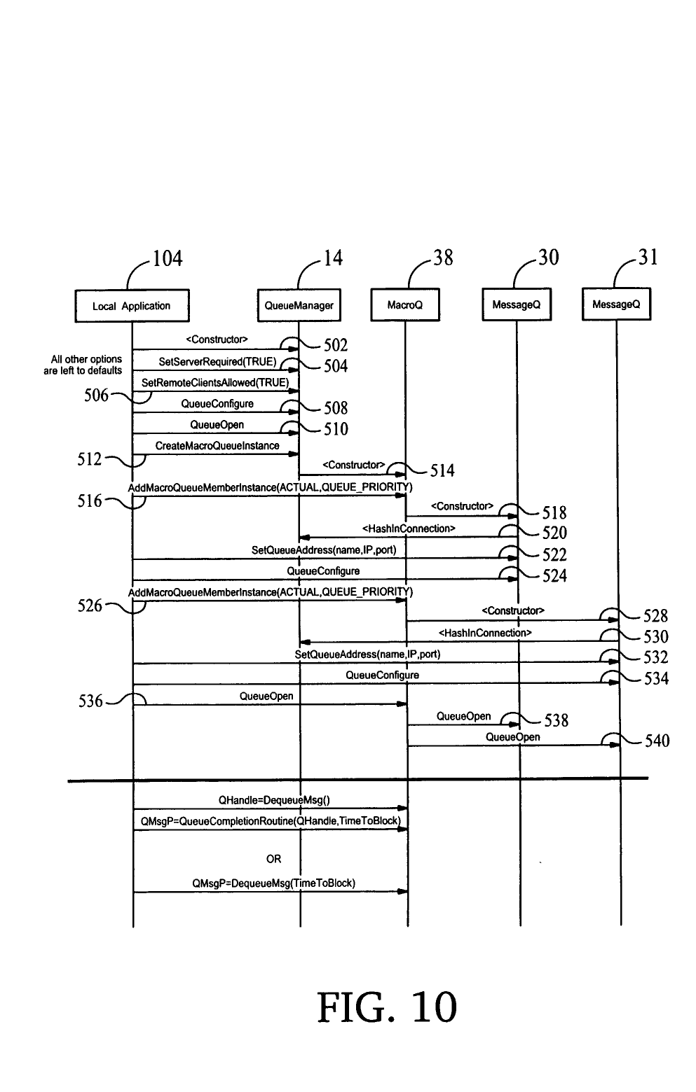

FIG. 10 is a diagram showing the steps for creating a macro queue having two message queues. The message queues are configured through the instance pointer prior to calling the QueueOpen function. The consumer options are tested for each call to the DequeueMsg function. This will either analyze the prioritized mechanism (empty highest priority queues first) or empty the queues chronologically as the messages are added to the queues. In steps 502 to 510, a queue manager 14 is created and configured.

In step 512, process 104 calls the CreateMacroQInstance function to instruct the queue manager 14 to create a macro queue 38. In step 514, queue manager 14 calls a constructor to create a MacroQueue instance 38. In step 516, process 104 calls a AddMacroQMemeberInstance function to instruct the macro queue 38 to add a message queue. The AddMacroQMemeberInstance function also sets the priority for the message queue 30 that is added to the macro queue 38. In steps 518 to 524, a message queue 30 is created and configured. In step 526, process 104 calls the AddMacroQMemeberInstance function to instruct macro queue 38 to add another message queue and to set the priority value for the new message queue. In steps 528 to 534, a message queue 31 is created and configured. In step 534, process 104 calls the QueueOpen function to open the macro queue instance 38. In step 538, the macro queue instance 38 calls the QueueOpen function to open the message queue 30. In step 540, the macro queue 38 calls the QueueOpen function to open the message queue 31.

FIG. 11 is a diagram showing the steps for creating RemoteQProxy instances to connect to a remote message queue and sending a message to the remote message queue. In steps 602 to 606, a queue manager 14 is created and configured. In step 608, the queue manager 14 calls a constructor to create a remote queue proxy 50a. In step 610, remote queue proxy 50a calls a constructor to create a SessionProtocol instance 60a that is part of a communication stack 52a and is used to establish a connection with the network 5. In step 612, process 106 calls the QueueOpen function to open the QueueManager 14. In steps 614 to 618, a remote queue proxy 50b and a SessionProtocol instance 60b are created at the queue side (local side). In step 620, a RemoteQueueProxy instance pointer pointing to the remote queue proxy 60b at the queue side is returned to the queue manager 14.

In steps 622 to 626, the remote queue proxy instance 60a is configured and opened. In step 628, the remote queue proxy 60a calls the SessionOpen function to open a session. In step 630, remote queue proxy 60a calls the RemoteQProxy_Open_Request function to request to open a RemoteQProxy instance at the queue side. When the queue manager at the queue side receives the RequestQProxy_Open_Request, the queue manager will search for an available message queue and return a pointer pointing to the queue. In step 630, an acknowledgment that a connection to the remote message queue has been established is sent to the RemoteQProxy instance 60a. In step 634, a an acknowledgement is sent to application 640 indicating that the RemoteQueueProxy instance at the queue side is ready. In step 636, application 640 calls the EnqueueMsg function to add a message to the RemoteQueueProxy instance 644. In step 644, remote queue proxy 60a calls the QSSendMessage function to forward the message to the remote message queue.

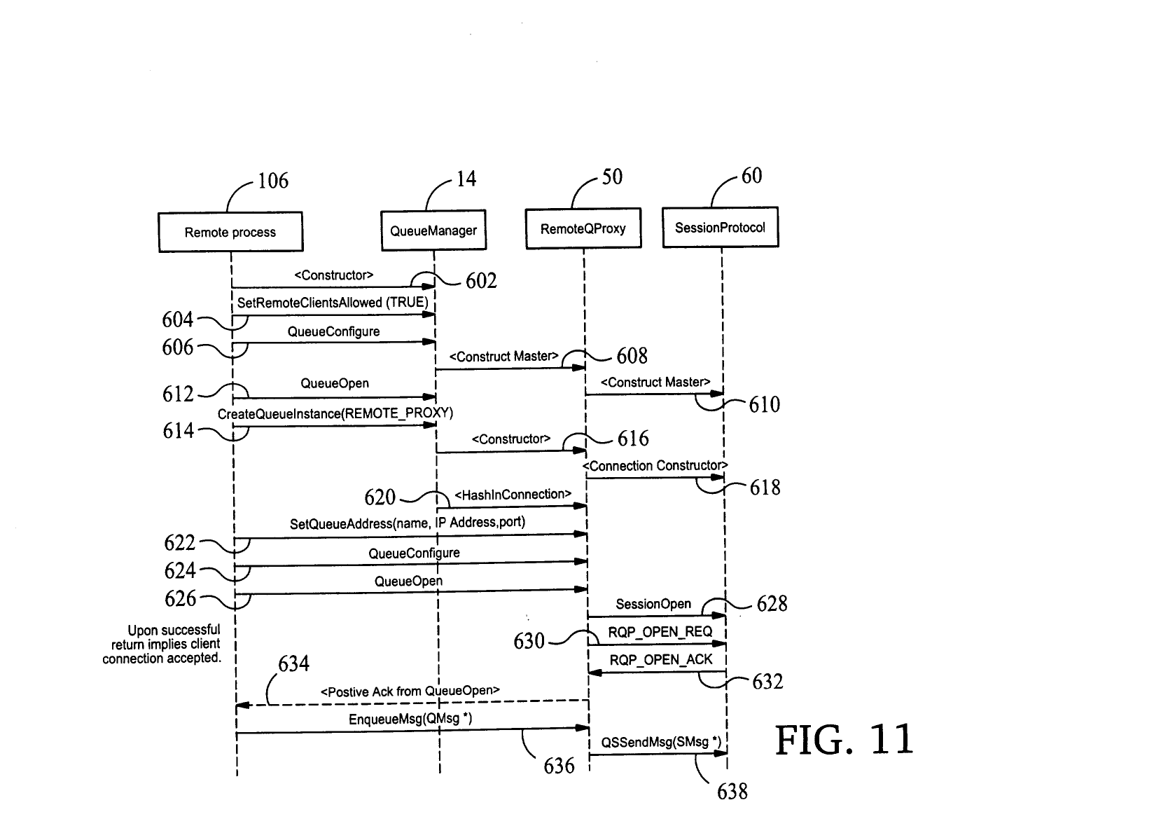

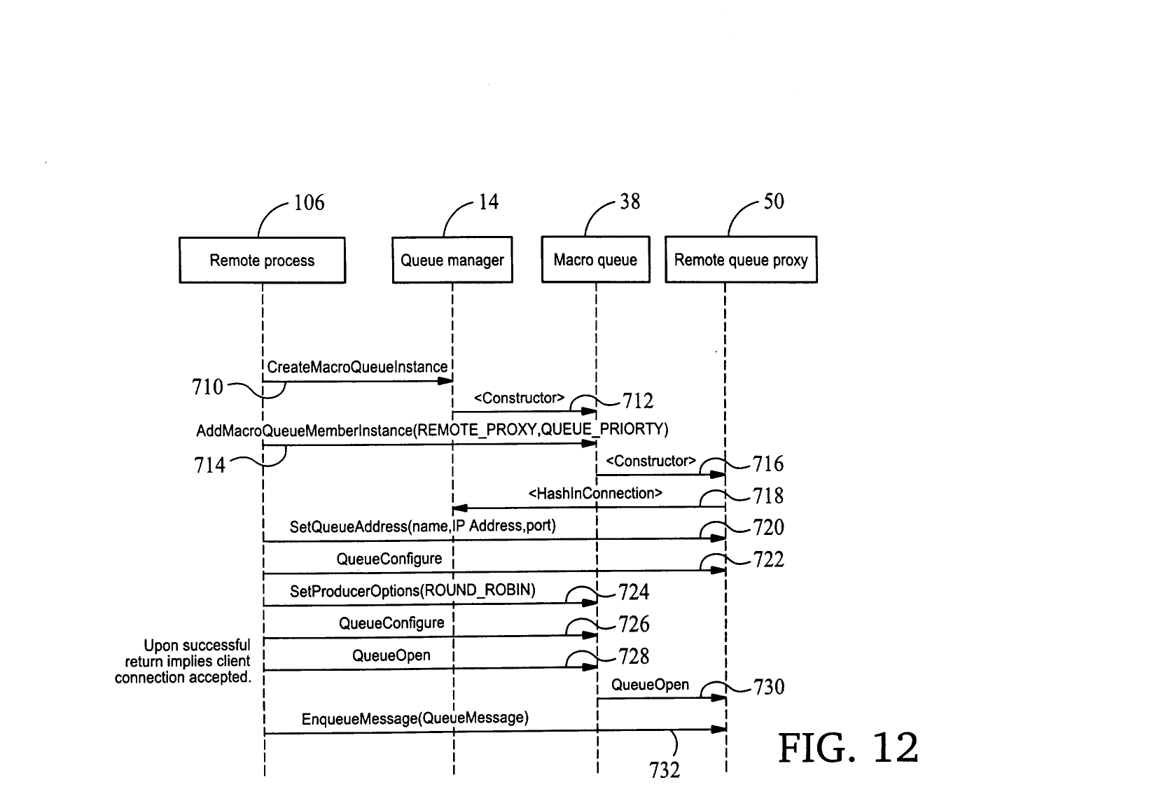

FIG. 12 is a diagram showing the steps for configuring a macro queue as a producer queue and the steps for adding a message to a remote queue that is a member of the macro queue. It is assumed that prior to step 710, a QueueManager instance 14 has been created, configured, and opened. In step 710, remote process 106 instructs queue manager instance 14 to create a macro queue 38. In step 712, a MacroQueue instance 706 is created. In step 714, remote process 106 calls the AddMacroQMemberInstance function to instruct macro queue 38 to add a member queue. Note that the parameter “Remote_Proxy” is passed to the AddMacroQMemberInstance function, so that a RemoteQProxy instance is added as a member of the macro queue 38. In steps 716 to 722, a remote queue proxy 50 is created and attached to a remote message queue. In step 724, process 106 calls the SetProducerOptions function to specify that macro queue 38 is set as a producer macro queue, and that the criterion for selecting member queues in the macro queue will be in a round robin fashion. In steps 726 and 728, the macro queue 38 is configured and opened. In step 730, macro queue 38 calls the QueueOpen function to open the remote queue proxy 50. In step 732, process 106 calls the EnqueueMsg function to send a message to the remote queue proxy 50, which forwards the message to the remote message queue.

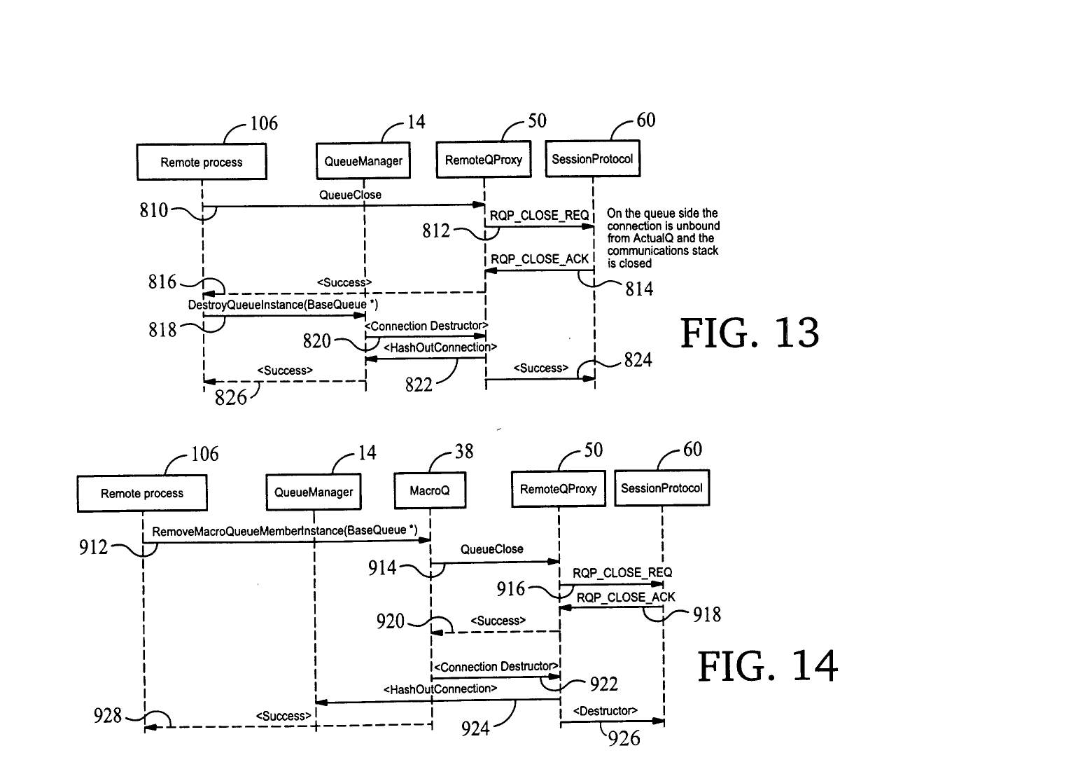

FIG. 13 is a diagram showing the steps for closing and destructing a remote queue connection. In step 810, remote process 106 calls the QueueClose function to close a remote queue proxy 50. In step 812, remote queue proxy 50 calls the RemoteQueueProxy_Close_Request function to close the SessionProtocol instance 60. For remote queues, this sets the state of both RemoteQueueProxies on the remote side and the queue (local) side to a “closed” state. In step 814, an acknowledgement is sent to the remote queue proxy 50 indicating that the remote queue proxies are closed. In step 816, an acknowledgement is sent to process 106 indicating success of the closing of the remote queue connection. In step 818, process 106 calls the DestructQueueInstance function to destruct the remote queue connection by clearing the memory allocated for the RemoteQueueProxies. In step 820, queue manager instance 14 invokes a connection destructor, which causes remote queue proxy 50 to invoke a destructor in step 824. In step 822, the pointer pointing to the remote queue is removed from the hash table. In step 826, an acknowledgement is sent back to remote process 106 indicating success of destructing the remote queue connection.

FIG. 14 is a diagram showing the steps for removing a remote queue proxy from a macro queue. In step 912, remote process 106 calls the RemoveMacroQMemeberInstance function to instruct a macro queue 38 to remove a RemoteQueueProxy instance. In step 914, macro queue 38 calls the QueueClose function to instruct remote queue proxy 50 to close the remote queue connection. In steps 916 and 918, the remote queue connection is closed, and an acknowledgement is sent back. In step 920, and acknowledgement of successful closure of the remote connection is sent to macro queue 38. In step 922, macro queue 38 invokes a connection destructor to instruct the remote queue proxy 50 to destruct the remote queue connection in step 926. In step 924, the pointer to the remote queue is removed from a hash table. In step 928, an acknowledgement is sent back to remote process 106 indicating success of the destruction of the remote queue connection.

Remote Queuing Protocol

When a remote queue connection is established, several internal messages are passed between the remote RemoteQueueProxy and the RemoteQueueProxy on the queue side. (Note: The term “internal message” will be used to refer to a message that is passed among various components of the message queuing system for controlling or configuring the various components. The term “external message” will be used to refer to a message that is sent from an external source that is intended to be stored in a message queue.) The queue side RemoteQueueProxy class is responsible for making the local calls into the MessageQueue on behalf of the remote side. The protocol for exchanging internal messages among the various software components of the queuing system is called Remote Queuing Protocol.

A QueueMessage class is used for the internal messages passed between the remote queue proxies. The QueueMessage class inherit from the SessionMessage class, which in turn inherits from the TransportMessage class. This approach allows for the future splitting of the separate layers and greater modularity. A set of QueueMessage instances are pre-allocated when a MessageQueue instance or a RemoteQueueProxy instance is created. A default number of QueueMessage instances is constructed, the default number being equal to 50% of the maximum queue depth. When new internal messages are needed, they are allocated off of a heap and then returned back to a free list that is managed by the queue. This allows the queue to have pre-allocated QueueMessage control blocks that have already been allocated for use. This increases system performance. This allocation occurs from a static function that is accesssible through the SessionProtocol layer as well as above the queuing layer. The QueueMessage class also contains the QueueElement class to allow easy linkage to the MessageQueue instances.

The QueueMessage class is used to hold a pointer to the data to be sent and received. Because the queuing system uses a hierarchical inheritance tree, each layer knows where the relevant buffer for a piece of information starts and how many bytes it is. A pointer m_CurrentBufferPointer will be assigned at the Transport layer so that as the data is filled in by each layer, the pointer will move up, pointing to the appropriate layer's memory. The QueueMessage class will have a pointer to the m_ApplicationDataPointer which allows the application to have access to the start of its data. Each layer accesses the pointer information of the lower layers to decide where the data starts in memory and how long the data is. This approach allows the dynamic allocation and copying of incoming internal messages to be done only once. Hooks will be put into place to allow for calls to the Dequeue function that returns only a pointer to the data instead of a complete class.

The internal messages that are passed between the remote queue proxies are listed in Table 10. Each of the internal messages contains a sequence number that is used to correlate the acknowledgements to the request. The internal messages are stored in the QueueMsg class to pair them up.

Queuing Type Message Flows

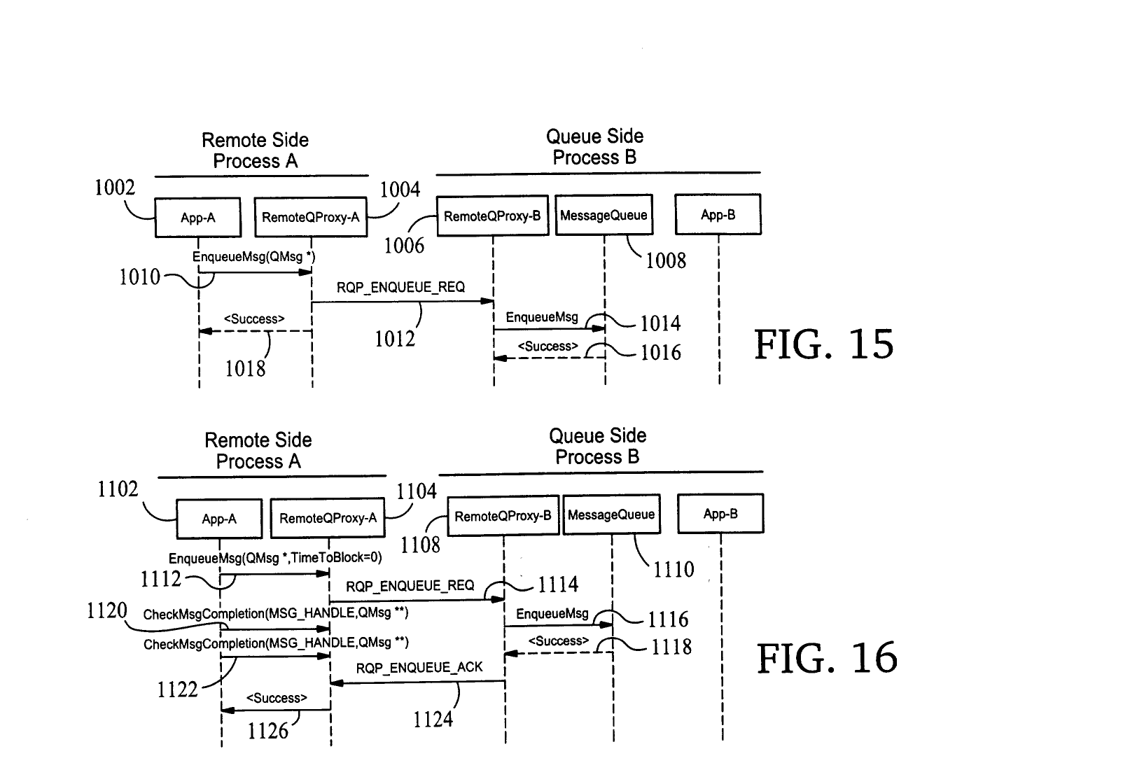

FIG. 15 is a diagram of an example of a queuing messaging flow for a one-way queue when an EnqueueMsg function is called. Application A 1002 belongs to process A, and application B belongs to process B. In step 1010, application A 1002 calls the EnqueueMsg function and passes a QueueMsg pointer to RemoteQProxy instance 1004. In step 1012, RemoteQProxy instance 1004 sends a RQP_ENQUEUE_REQ message to RemoteQProxy instance 1006. In step 1014, RemoteQProxy instance 1006 calls an EnqueueMsg function to enqueue an external message to MessageQueue 1008. In step 1016, an acknowledgement is sent back to RemoteQProxy 1006 indicating that the external message was successfully enqueued. In step 1018, an acknowledgement is sent back to application A 1002 indicating a successful return from the EnqueueMsg function call.

TABLE 10

| | Value | Description |
|---|---|---|
| To Queue Side | | |
| RQP_OPEN_REQ | 1 | Sent to the queue side to open up a |
| | | queue connection and bind to a |
| | | MessageQueue instance. Included is the |
| | | name, IP address, port and Queue type. |
| RQP_CLOSE_REQ | 2 | Used to close only this connection to the |
| | | queue. |
| RQP_ENQUEUE_REQ | 3 | Used to send a message to the remote |
| | | queue and queue the message. This |
| | | contains the data to be put on the queue. |
| RQP_DEQUEUE_REQ | 4 | Message to retrieve a message off of a |
| | | remote queue. |
| RQP_GET_STATS REQ | 5 | Used to request statistics of a queue. |
| RQP_GET_QMGR_STATS | 6 | Used to request statistics of a queue |
| | | manager. |
| From Queue Side | | |
| RQP_OPEN_ACK | 17 | Acknowledgement to the Open function. |
| RQP_CLOSE_ACK | 18 | Acknowledgement to the Close function. |
| RQP_ENQUEUE_ACK | 19 | Acknowledgement to the Enqueue |
| | | function, is used for sequencing of queue |
| | | types in the RemoteQProxy class. It is |
| | | not sent for One_Way queues. |
| RQP_DEQUEUE_ACK | 20 | Returns the message from the queue |
| | | when one becomes available. |
| RQP_GET_STATS_ACK | 21 | Returns the statistics of the queue. |
| RQP_GET_QMGR_STATS_ACK | 22 | Returns the statistics of the queue |
| | | manager. |
| RQP_ERROR_ACK | 23 | Generic error acknowledgement to any |
| | | requested message. It contains an error |
| | | status indicating what was in error. |

FIG. 16 is a diagram of an example of a queuing messaging flow for a one-way-acknowledged queue when an EnqueueMsg function is called. In step 1112, application A 1102 calls the EnqueueMsg function and passes a QueueMsg pointer and a TimeToBlock parameter to RemoteQProxy instance 1104. The TimeToBlock paramter is set to zero, indicating that the function should return right away with the MSG_HANDLE. In step 1114, RemoteQProxy instance 1104 sends a RQP_ENQUEUE_REQ message to RemoteQProxy instance 1108. In step 1116, RemoteQProxy instance 1108 calls an EnqueueMsg function to enqueue an external message to MessageQueue 1110. In step 1118, an acknowledgement is sent back to RemoteQProxy 1108 indicating that the external message was successfully enqueued.

Application-A 1102 can check the status of the acknowledgement by calling a CheckMsgCompletion rountine (step 1120) with the MSG_HANDLE and a pointer to a QueueMsg pointer as arguments. The CheckMsgCompletion function will return a pointer to the acknowledgement if the acknowledgement was received. When a RQP_ENQUE_ACKNOWLEDGMENT message is received, a MsgCompleted routine is called, passing a pointer to a QueueMsg response. RemoteQProxy instance 1104 stores a copy of the message sent to the other side (e.g., from the remote side to the queue side), and the dynamic MSG_HANDLE is stored in a hash list. When a response is received, a simple hash look up is performed on a ReferenceID parameter to be returned to the application through the MsgCompleted routine.

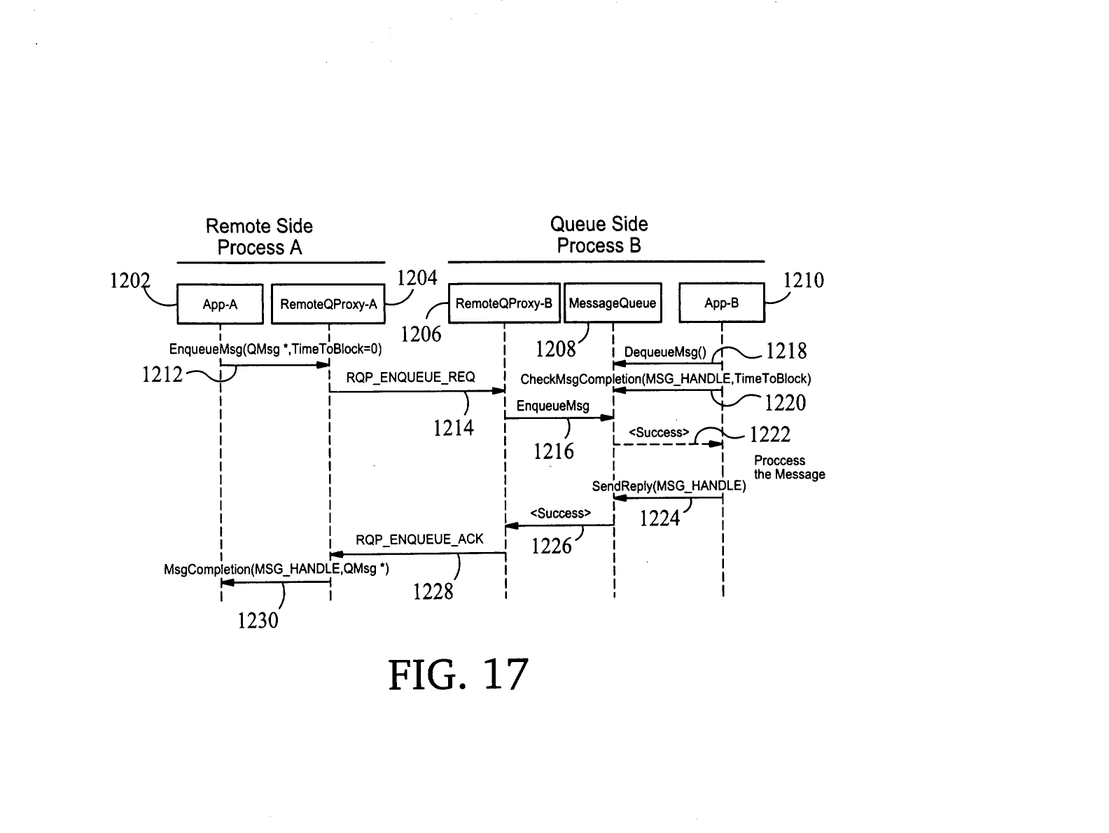

FIG. 17 is a diagram showing the queuing message flow for a two-way queue when the EnqueueMsg and the DequeueMsg functions are called. In the example given, the EnqueueMsg function is called in a non-blocking manner. In step 1212, application A 1202 calls the EnqueueMsg function and passes a QueueMsg pointer and a TimeToBlock parameter to RemoteQProxy instance 1204. The TimeToBlock paramter is set to zero, indicating that the function should return right away with the MSG_HANDLE parameter. In step 1214, RemoteQProxy instance 1204 sends a RQP_ENQUEUE_REQ message to RemoteQProxy instance 1206. In step 1216, RemoteQProxy instance 1206 calls an EnqueueMsg function to enqueue an external message to MessageQueue 1208. In step 1218, application-B 1210 calls the DequeueMsg function to dequeue the external message from MessageQueue instance 1208. In step 1220, application-B 1210 calls a CheckMsgCompletion function, passing the MSG_HANDLE and TimeToBlock parameters. In step 1222, an acknowledgement is sent back to application-B 1210 indicating that the external message was successfully dequeued.

A MsgCompleted function is called when the application-B 1210 calls a SendReply function. If application-A 1202 calls the CheckMsgCompletion function, it can track the internal messages through the MSG_HANDLE. Application-A 1202 can also ignore the internal messages. The external message enqueued to the B side queue will also be queued to the RemoteQProxy instance 1204. The complete external message is not sent from the B side back to the A side for performance reasons. On the B side, since the configuration is a two way queue, the MessageQueue logic keeps track of the queue's unique MSG_HANDLE's. The same mechanism for the MSG_HANDLE is achieved as described above in the One_Way_Acknowledged queue.

MacroQueue Blocking Mechanism

The interface for the MacroQueue allows for blocking calls of the EnqueueMsg, DequeueMsg or CheckMsgCompletion functions. When these functions are blocked, they will call routines that wait on an event from the RemoteQProxy or MessageQueue classes to signal when a message has arrived. This is achieved using a mutex variable along with condition variables. Mutex variables are used to control access to shared resources. The MacroQueue instance waits on a Cond_TimedWait function call. This call waits (and blocks a calling thread) for a given amount of time or until the condition that it is waiting on is received through the Cond_Signal function. A single mutex is defined for the queue manager. If the MessageQueue's or RemoteQProxy's are to be part of a macro queue, then when a message arrives or when a message is enqueued, it will lock the mutex, set a bit mask indicating the queue that received the message and send the Cond_Signal function with the condition variable. The MacroQueue will wake up, implying that it has not locked the mutex check which queues need service, perform the consumer or producer action based upon which one is configured, clear the bit mask, then unlock the mutex. This will allow further processing from the application task, and allow more events to be sent from the queues. Once the application wants to block again, it will lock the mutex and call the Cond_TimedWait function again. Typically, this will be used when the MacroQueue is a consumer. The producer MacroQueue is driven by commands sent from the SessionProtocol layer.

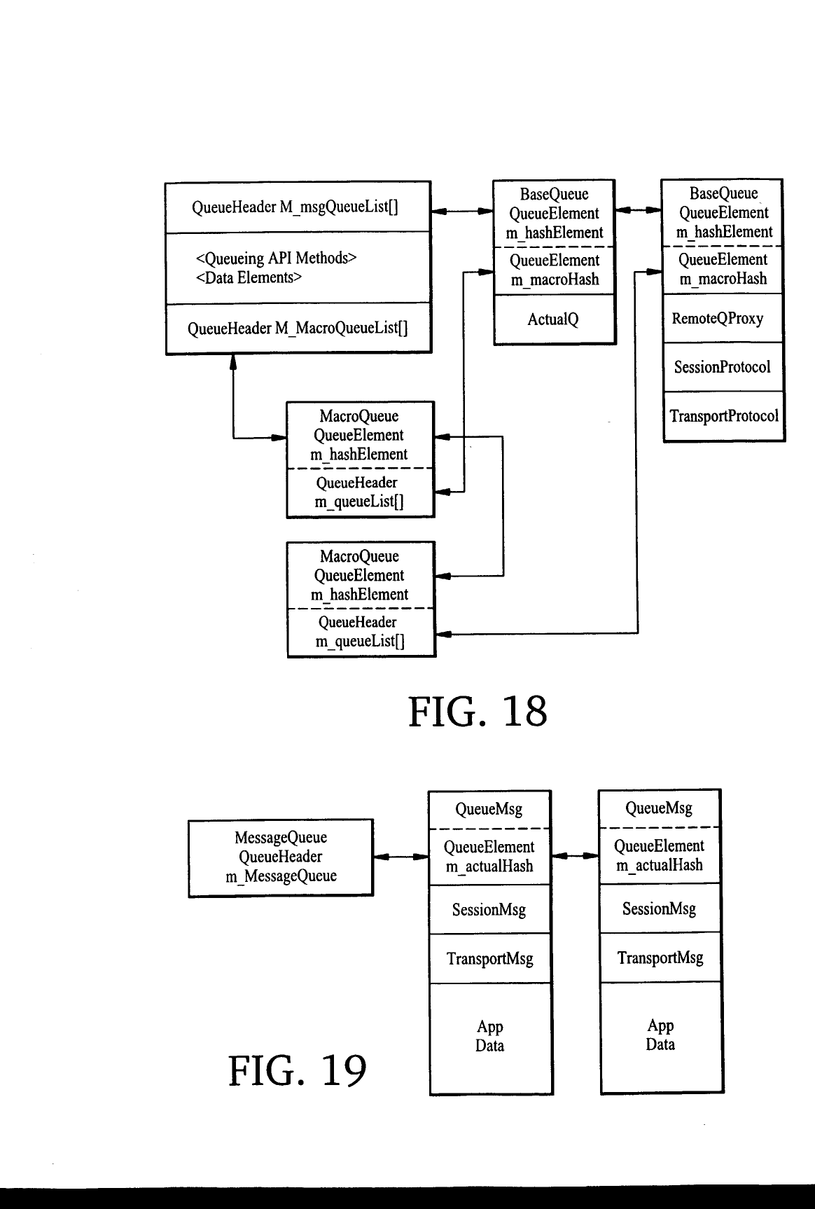

Referring to FIG. 18, all of the lists managed by the QueueManager and the MacroQueue instances are achieved through a hash table. The mechanism requires an array of hash bucket QueueHeader instances which is a mechanism to manage a doubly link list of QueueElements. Each item to be queued, RemoteQProxy's, QueueMsg's, MessageQueue's have multiple QueueElements that are used by the QueueHeader's head and tail pointers. This mechanism does not require objects that are to be queued to have another storage area for their forward and backward references; instead, it will be the QueueElement.

FIG. 19 is a diagram showing how QueueMsg types are linked onto a MessageQueue instance.

Each queue has a finite state machine that tracks the state of the queue or the connections to the queue. The values that can be set are: UNKNOWN, CONFIGURING, CONFIGURED, OPENING, OPEN, CLOSING, CLOSED and FAILED. After the constructors are called, the queue is put into the CONFIGURING state. The FAILED state will be reached if the connection is broken or the queue has hit a resource limitation. These states apply to the QueueManager, MessageQueue, RemoteQProxy and the MacroQueue classes.

Table 11 lists the function calls used by the RemoteQProxy class to control the SessionProtocol instances.

TABLE 11

| Name of function | Purpose of function |
|---|---|
| OpenSessionLayer( ) | Called to open the master SessionProtocol instance. This is a |
| | static function. |
| ConfigureSessionLayer( ) | Called to configure the master SessionProtocol instance. |
| | This is a static function. |
| CloseSessionLayer( ) | Called to close the master SessionProtocol instance and all |
| | connections associated with it. This is a static function. |
| OpenSession( ) | Used to open an individual connection stack. Eventually this |
| | will open a TransportProtocol connection. |
| CloseSession( ) | This is called when the RemoteQProxy calls the QueueClose |
| | method. It closes the transport connection, frees up memory |
| | associated with it and un-hashes itself from the master |
| | session instance's hash table. |
| QSSendMsg( ) | This is called when the RemoteQProxy has a QueueMsg |
| | class formulated and is ready to send to the session layer. |
| QSReportMsg( ) | When a message has progressed successfully through the |
| | transport and session layers and is ready to be presented to |
| | the queuing layer, the QSReportMsg( ) is called with the |
| | SMsg pointer. |
| SessionSetAddress( ) | This function is called to send the name of the queue to |
| | which the caller is trying to attach. The IP address of the |
| | server where the queue is, and the port number that the server |
| | is listening on are also sent by this function. |

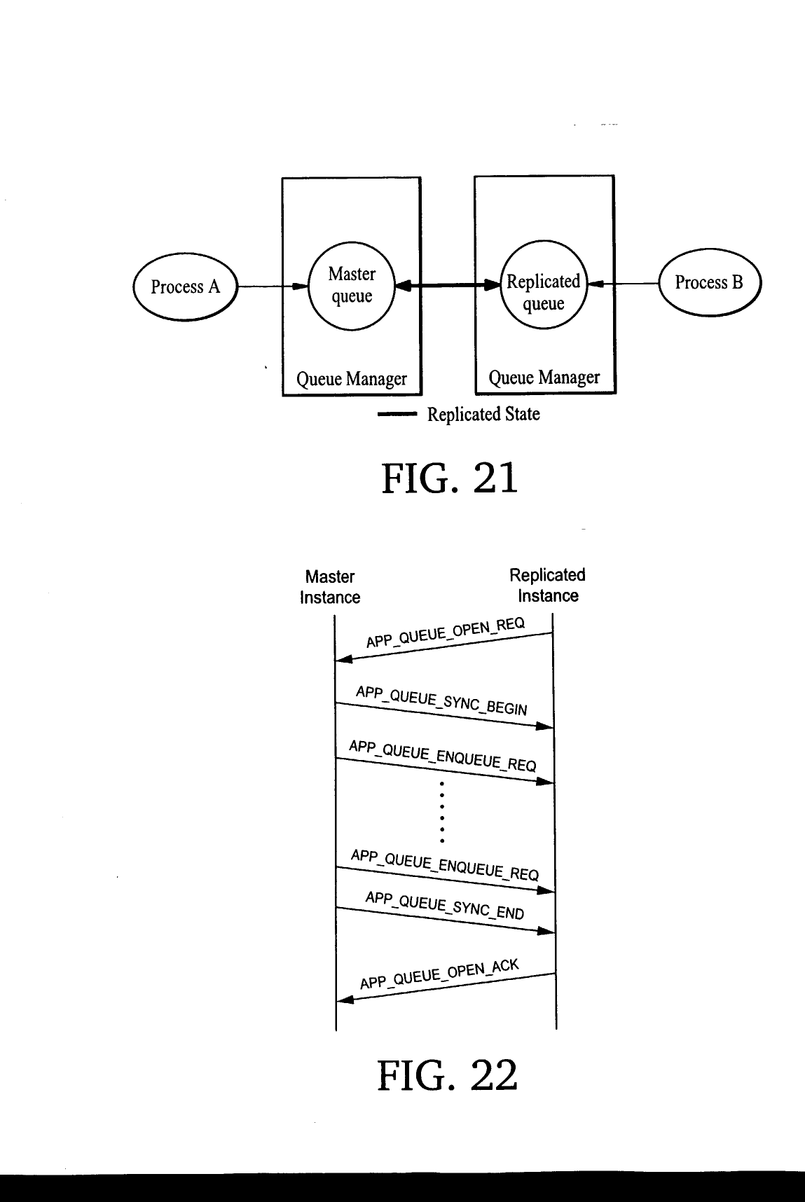

Referring to FIG. 21, a distributed replicated queue pair 70 is provided for fault tolerance. A replicated queue pair has two member queues: one member of the pair is the master queue instance and the other member is the replicated queue instance. The master instance determines ordering relative to messages placed on the replicated queue. Processes may connect to either the master queue or the replicated queue. The master and replicated queues may be physically distributed across a network or located within the same address space of a queue manager. Processes access the replicated queue without knowing that the queue is a replication of another queue, and without knowing that the replicated queue is physically located in another computer across a network.

Replicated queues are created by using a CreateReplicatedQueueInstance API call. The name of the queue instance is specified as well as the remote IP address and port number if the instance is remote with respect to the local queue manager instance. If the queue instance is not local, a remote connection is established. An open request includes the name of the queue, and the options field includes a replicated flag. The open request contains an additional field containing replication flags that is used to specify the replication strength of the queue. The replication strength contains a bit mask that is used to specify the following constants: PRODUCER_REPLICATION, or FULL_REPLICATION. The PRODUCER_REPLICATION option causes all messages queued by producer clients of either replicated member to be ordered and recorded in the queue. Note that specifying PRODUCER_REPLICATION only causes the member queue states to be replicated with respect to input messages. Each queue member must be serviced by a separate consumer to remove the messages queued as a result of producer message replication. The FULL_REPLICATION option causes all queue operations to be applied to both members of the replicated queue simultaneously. The FULL_REPLICATION option ensures identical queue states at either member at all times.

The first instance to exist of a given queue pair is deemed the master instance. Optionally, the MASTER_REQUIRED option may be specified during open to require that the queue instance be opened as the master instance. In the event a master instance already exists for the named queue and the MASTER_REQUIRED flag has been set, the opened instance must either be the first instance or the open operation will fail with an error code of E_MASTER_EXISTS. If the MASTER_REQUIRED option has not been specified and the queue already exists, the queue state of the new instance will be synchronized with the existing queue state through a State Transfer sequence. The State Transfer sequence replicates the queued messages of the existing queue in the same order on the new replicated member queue instance. Once the state transfer has completed, the new instance enters the operational state and the queues maintain synchronization as specified through the replication strength in the open request. Following the open request, a replicated queue will adhere to queuing API defined earlier.

Sometimes it may be necessary to change the role of the master and replicated instance due to process failures, network failures, or scheduled maintenance. When a failure occurs, the queue manager runs an external routine to determine whether a particular instance will continue to execute as the master, or assume the role of the master. The external routine runs an alternate method to classify the failure to determine whether the replicated queue is still operational. If the alternate method determines that the peer replica is operational, the master instance is allowed to continue and the replicated instance is designated a failed instance. Upon restart, the failed instance reconnects and go through the state transfer process. When the role of master and replicated instances are change due to an orderly shutdown, the role of master is “handed-off” to the replicated instance if the current master instance is being shutdown. The shutdown instance may be re-established in the future as a replicated instance following the state transfer procedure.

Distributed Queue Replication Protocol

Queue managers of the distributed message pairs communicate with each other to achieve synchronization of the replicated pairs. The communication channel is managed by the queue manager to allow multiple named queue instances to be replicated over the same queue manager to queue manager connection. The connection involves opening a session and transport connection between the two queue managers to allow queue replication protocol messages to flow. The format and the protocol sequences of the queue replication messages resemble remote queue manager protocol messages. Additional open options are provided in the open request for replicated queues as described below.

The distributed queue replication protocol is a set of extensions made to a remote queue protocol. In addition to option fields in the APP_QUEUE_OPEN and APP_QUEUE_OPEN_ACK messages, the open sequence is extended to include queue state synchronization. Queue state synchronization procedure is bracketed by the open request and the resulting acknowledgement message. The net result is that the queue is deemed synchronized and operational following the acknowledgement of the open request that is delivered after the queue synchronization procedure has been completed. The queue synchronization procedure transfers a copy of the messages on the master queue instance to the replicated instance. This process involves sending a series of successive APP_QUEUE_ENQUEUE_REQ messages as a result of the open request made by the replicated instance. The master instance initiates the queue state synchronization procedure by sending an APP_QUEUE_SYNC_BEGIN message to the replicated instance. The master instance then sends successive APP_QUEUE_ENQUEUE_REQ messages for each message on the queue until all messages have been transferred, at which point an APP_QUEUE_SYNC_END message is sent. The replicated queues should then contain the same messages. The replicated instance responds with an acknowledgement to the original open request and the replicated queue transitions to the open state. FIG. 22 is a diagram showing a queue replication protocol sequence.

Each queuing operation acknowledgement (Enqueue, Dequeue, SendReplyMSG, etc.) carries an additional field that is used by the master instance to order messages. The field is set to zero by the replicated instance when sending acknowledgements back to the master. The acknowledgements sent by the master instance, on the other hand, populates the field with an ordering index that orders the requests relative to other requests made on the replicated queue. Typically the replicated instance holds the request message off to the side until an acknowledgement is provided by the master instance that specifies the ordering relative to other requests in the queue.

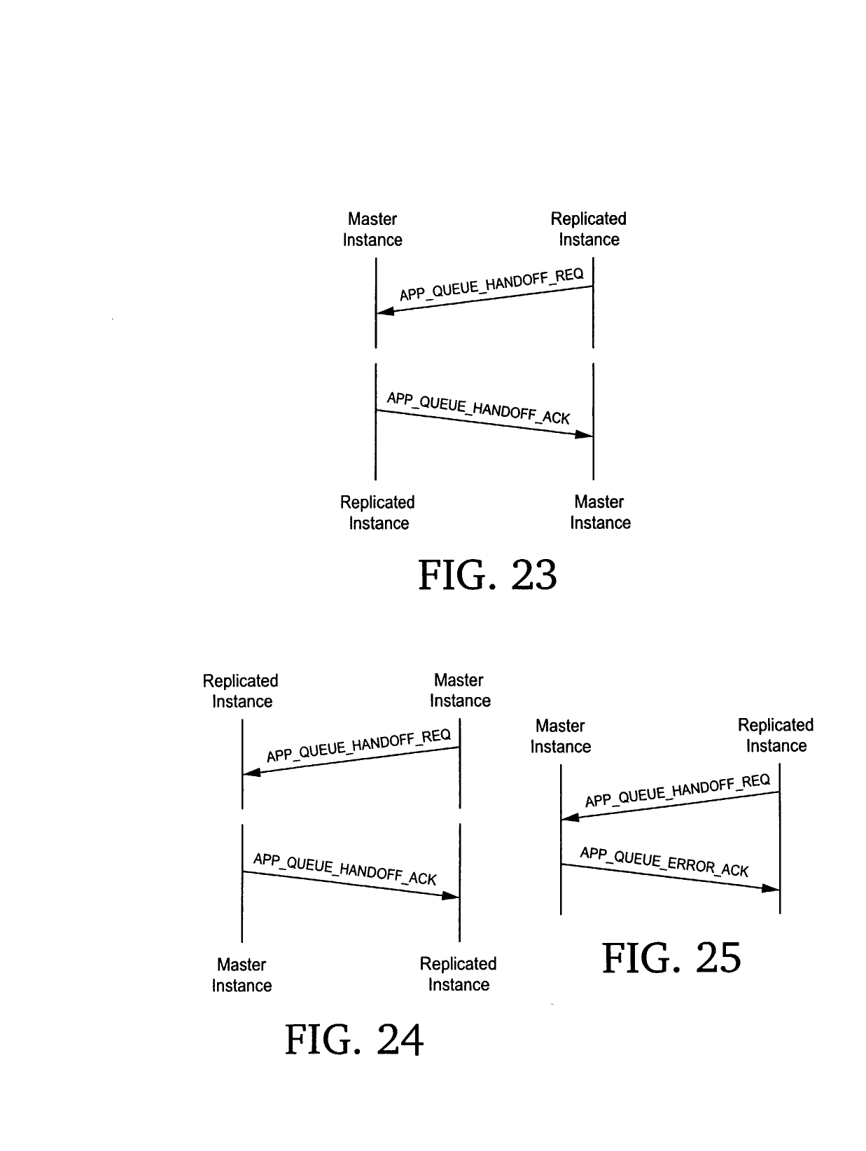

As mentioned above, it may be necessary for the master to handoff the role of message ordering when shutting down in an orderly fashion. In addition, the replicated instance may request a handoff based on conditions external to the queue manager and the queuing subsystem. Typically, client handoff requests are performed when requested, although it may be possible for the master to reject the request and return a negative acknowledgement, at which point the requesting instance may close the queue, or continue on as a replicated instance. If the master and the replicated instance initiate the handoff procedure at the same time, the replica request will fail and the master instance request will be processed. FIG. 23 is a diagram showing a successful replica initiated handoff protocol sequence. FIG. 24 is a diagram showing a successful master initiated handoff protocol sequence. FIG. 25 is a diagram showing an unsuccessful replica initiated handoff protocol sequence.

The queuing API's are extended to support queue replication. Extensions to both the administrative and the queuing interfaces are provided. The administrative extensions are limited to a single new call to create a replicated queue instance. For purpose of queue replication, the queuing API is used between the queue managers to replicate the queue state rather than between the consumer and producer processes. Note that communication between queue managers are typically initiated as a result of operations performed by one of the consumer or producer clients on one of the replicated instances. The operation then causes an operational equivalent to be performed across the replicated queue communication channel. Table 12 shows the administrative queue API replication extensions. Table 13 shows the queuing interfaces supported between the queue managers of the replicated instances.

TABLE 12

| Administrative API Call | Description |
|---|---|
| CreateReplicatedQueueInstance | Creates a new replicated queue instance that assumes the |
| | default options contained in the MasterQueueObject. |

TABLE 13

| Queuing API Call | Description |
|---|---|
| QueueOpen | Causes replicated queue instance activation including queue state |
| | synchronization in cases where the queue already exists. Following |
| | successful completion of the open request the replicated queue peers |
| | will be in a synchronized state. Also serves to mark the end of the |
| | replicated queue configuration phase. |
| QueueClose | Closes a replicated queue peer instance. The queue may cease to |
| | exist if this is the last instance. |
| QueueStats | Returns a set of statistics for the queue object including the queue |
| | object replication state, master instance status, and the totals relating |
| | to the total number of queued messages, current number of queued |
| | messages, actual maximum queue depth, configured maximum |
| | queue depth, average queue service time, number of local clients, |
| | number of remote clients, number of consumer clients, and the |
| | number of producer clients. |
| SetQueueOptions | This method allows the replicated queue options to be set for the |
| | local copy of the queue object. These default values will be used |
| | upon queue activation following the QueueOpen request. |
| GetQueueOptions | This method returns the current replicated queue options |
| | configuration. |
| EnqueueMSG | Called by a master or replicated Queue Manager instance to place a |
| | message on the specified replicated queue. |
| DequeueMSG | Called by a master or replicated Queue Manager instance to retrieve |
| | a message from the specified replicated queue. |
| SendReplyMSG | Called by a master or replicated Queue Manager instance to send a |
| | reply to a previously retrieve a message from the specified replicated |
| | queue. |
| QueueCompletionRoutine | Callback routine that is called following the completion of a |
| | previously issued request. |
| MasterHandoffRequest | A routine that initiates the message ordering handoff procedure. |
| | This routine may be called by either the master or replicated |
| | instance. |

Appendix A is an example of a C++ program that may be used to construct and configure a QueueManager instance and to create a MessageQueue instance.

Having described a detailed implementation of the message queuing system 10, the following describes the application of the message queuing system 10 in a wireless communication system as described in co-pending application Ser. No. ______, filed Feb. 2, 2002, incorporated herein by reference.

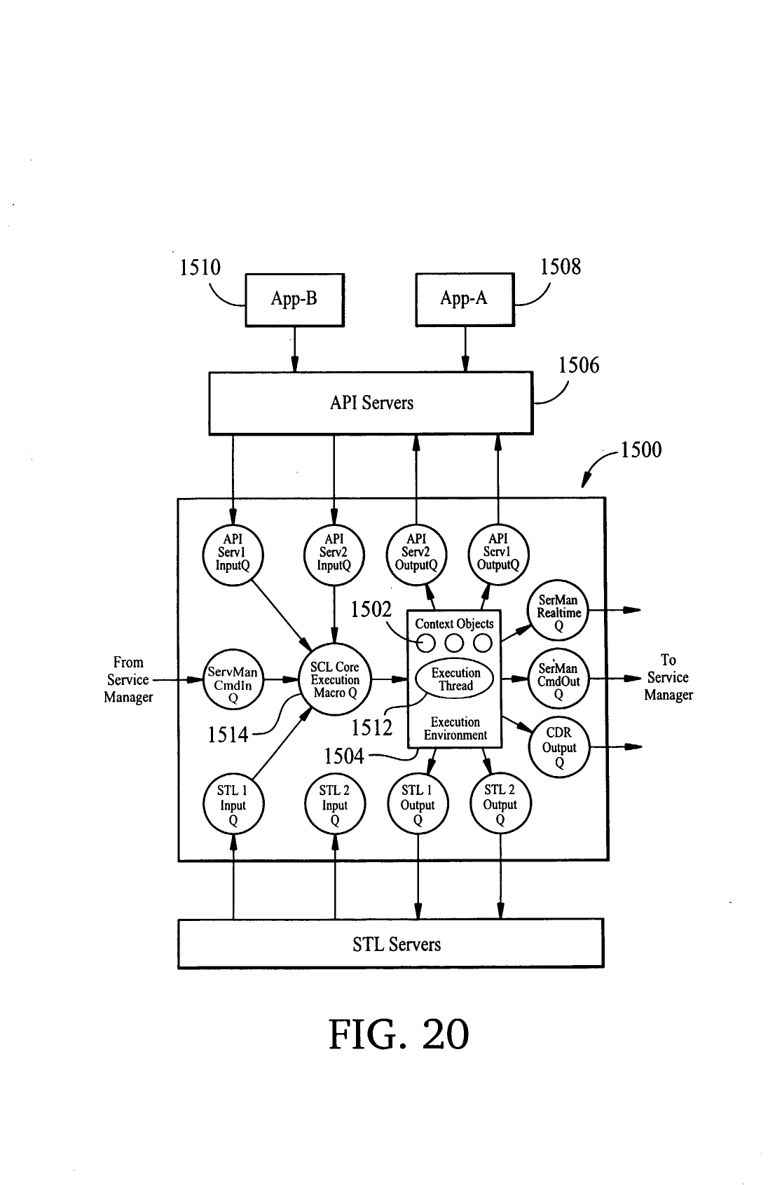

FIG. 20 shows a top level architecture of a Service Core Layer (SCL) core 1500 of a wireless communication system. The SCL core is a central component of a SCL layer, which supports the infrastructure necessary to interface to external processes. Various processes (e.g., 1508, 1510) of the wireless communication system exchange messages to update a set of contextual objects 1502 belonging to the SCL core 1500. The SCL contextual objects 1502 are updated by SCL scripts that are activated based on the reception of messages sent from processes through the API servers 1504. As an example, each component in the SCL core 1500 may be a process running in the Solaris operating system.

The SCL core 1500 includes an execution environment 1504 that processes messages. The SCL core 1500 maintains a replicated execution environment that is used to process and route messages to and from the various architectural elements of the SCL layer. All critical state information are stored within the SCL core 1500. The execution environment 1504 consists of a set of contextual objects 1502, a set of active scripts, and an execution thread 1512. The execution thread 1512 continually reads messages from an input macro queue 1514. The macro input queue 1514 serves to prioritize the input messages for the execution thread 1512. The execution thread 1512 dequeues the message at the head of the input macro queue and run the script scheduled to handle the message to be processed.

[image]

[image]

What is claimed is:

1. A method of managing messages, comprising:
storing messages in a plurality of queues;
providing a macro queue associated with the plurality of queues;
calling an application programming interface to initiate a request to the macro queue to obtain a message stored in one of the plurality of queues without identifying a particular queue; and
selecting a queue from among the plurality of queues and selecting a message from the selected queue.

2. The method of claim 1, further comprising assigning a priority value to each of the plurality of queues.

3. The method of claim 2 wherein the macro queue selects a message from a queue having the highest priority value.

4. The method of claim 1 wherein the macro queue selects a message that has been stored in the plurality of queues for the longest time.

5. The method of claim 1, further comprising providing a remote queue proxy for establishing a communication link between a remote application programming interface and the macro queue.

6. The method of claim 1 wherein the plurality of queues and the macro queue are software objects that are implemented using object oriented programming principles.

7. The method of claim 6, further comprising calling a software function of the macro queue object to associate a queue object with the macro queue object, wherein the software function returns a queue instance pointer pointing to the location of the queue object and a priority value representing the priority of the queue.

8. The method of claim 6, further comprising calling a software function of the macro queue object to remove the association between the macro queue and a queue.

9. A method of managing messages, comprising:
providing an application programming interface (API) to allow a producer module to send a message to a macro queue that manages a plurality of queues, the API sending the message to the macro queue without identifying one of the plurality of queues.

10. The method of claim 9 wherein the macro queue selects the first queue that is available among the plurality of queues and sends the message to the selected queue.

11. The method of claim 9 wherein the macro queue duplicates the message and sends the message to all of the plurality of queues.

12. The method of claim 9 wherein the macro queue selects a queue from among the plurality of queues that has the fastest response time based on previous response time records and sends the message to the selected queue.

13. The method of claim 9 wherein the macro queue selects a queue by cycling through each of the plurality of queues in a round robin fashion, and sends the message to the selected queue.

14. The method of claim 9 wherein the macro queue and the plurality of queues are implemented as software objects according to objected oriented programming principles.

15. A method comprising:
keeping a list of queue pointers, each pointer pointing to one of a plurality of queues;
receiving a request for adding a queue element; and
servicing the request by selecting one or more queue pointers from the list based on a predetermined criterion and adding the queue element to the one or more queues that the selected one or more queue pointers are pointing to.

16. The method of claim 15 wherein the predetermined criterion is to select a queue pointer pointing to a queue that has the shortest response time.

17. The method of claim 15 wherein the predetermined criterion is to select all of the queue pointers.

18. The method of claim 15 wherein the predetermined criterion is to select a queue pointer from the list in a round robin fashion by cycling through each of the queue pointers in the list.

19. A method comprising:
keeping a list of queue pointers, each pointer pointing to one of a plurality of queues;
receiving a request for retrieving a queue element; and
servicing the request by selecting one or more queue pointers from the list based on a predetermined criterion and retrieving a queue element from the one or more queues that the selected one or more queue pointers are pointing to.

20. The method of claim 19 wherein the predetermined criterion is to select a queue pointer pointing to a queue that is the first one to be available.

21. The method of claim 19 wherein each of the queues has a priority value, and the predetermined criterion is to select a queue pointers pointing to a queue having the highest priority value.

22. A method for messages communication in a distributed system, comprising:
providing an application programming interface on each computer of a group of computers in the distributed system;
providing a remote queue proxy on each of the computers of the group;
initiating a request through an application programming interface on a first computer of the group; and
passing said request to a second of the computers of the group by passing said request through the remote queue proxy on the first computer and the remote member queue proxy on said second computer.

23. The method of claim 22 wherein providing the application programming interface includes providing software objects implementing said interface that are implemented using object oriented programming principles.

24. The method of claim 22 wherein providing the remote queue proxy includes providing a software object implementing said proxy.

25. A method for passing messages between processes in a distributed system comprising:
providing an application programming interface to processes hosted on computers of the distributed system;
passing a first message from a first process to a second process hosted on one computer of the distributed system, including passing said message through a shared memory accessible to both the first process and the second process; and
passing a second message from the first process to a third process hosted on a second computer of the distributed system, including passing said message over a communication channel coupling the first and the second computers.

26. The method of claim 22 wherein the first process uses the same application programming interface to pass the first message and the second message.

27. The method of claim 22 wherein the first process is unaware of whether the first message and the second message are passing to a process hosted on the first computer or the second computer.

28. The method of claim 22 wherein providing the application programming interface includes providing a queuing interface for passing messages between computers.

29. The method of claim 22 further comprising:
providing a macro queue associated with the plurality of queues; and
wherein passing the first message from the first process to the second process includes calling the application programming interface to initiate a request to the macro queue to obtain a message stored in one of the plurality of queues without identifying a particular queue and selecting a queue from among the plurality of queues and selecting a message from the selected queue.

30. The method of claim 22 further comprising:
providing a remote queue proxy for establishing the communication channel between the first and the second computers.

31. A method for message passing in a distributed system comprising:
providing a queue manager on each of a group of computers in the distributed system;
providing an application programming interface to processes on each of the computers of the group, including providing an interface to accept and to provide messages for passing between processes hosted on the computers;
collecting operational statistics at each of the queue managers related to passing of messages between processes using the application programming interface; and
optimizing passing of the messages according to the collected statistics.

32. A method for fault-tolerant operation of a system comprising:
providing redundant processes for processing messages;
providing a separate replicated message queue for each of the redundant processes;
accepting a message for processing by each of the redundant processes;
enqueuing the message into each of the replicated message queues such that the order of message dequeuing form said queues by the redundant processes is synchronized.

33. The method of claim 22 wherein enqueuing the message into each of the message queues includes performing a logically atomic enqueuing operation on all the queues.

34. The method of claim 22 wherein providing each of said replicated queues includes providing a replicated macro queue associated with a plurality of replicated member queues of said macro queue.

35. A method of managing messages, comprising:
providing an application programming interface (API) to allow a producer module to send a message to a macro queue that manages a plurality of member queues, the API sending the message to the macro queue without identifying one of the plurality of member queues; and
using the same API to allow the producer module to send a message to an individual queue.

36. The method of claim 35 wherein the macro queue selects one or more of the member queues according to a predefined criteria.

37. The method of claim 36 wherein the macro queue, the member queues, and the individual queue are implemented as software objects according to object oriented programming principles.

38. A method of managing messages, comprising:
providing an application programming interface (API) to allow a consumer module to retrieve a message from a macro queue that manages a plurality of member queues, the API retrieving the message from the macro queue without identifying one of the plurality of member queues; and
using the same API to allow the consumer module to retrieve a message from an individual queue.

39. The method of claim 38 wherein the macro queue selects one of the member queues according to a predefined criteria and selects a message from the selected member queue.

40. The method of claim 39 wherein the macro queue, the member queues, and the individual queue are implemented as software objects according to object oriented programming principles.
